(19) United States
(12) Patent Application Publication
(10) Pub. No.: US 2003/0171953 A1
(43) Pub. Date: Sep. 11, 2003

(54) System and method for facilitating the exchange of health care transactional information

(76) Inventors: Suriya Narayanan, Round Rock, TX (US); Lee A. Root, Virginia Beach, VA (US)

Correspondence Address: COOLEY GODWARD, LLP, 3000 EL CAMINO REAL, 5 PALO ALTO SQUARE, PALO ALTO, CA, 94306, US

(21) Appl. No.: 10/284,587

(22) Filed: Oct. 30, 2002

Related U.S. Application Data
(60) Provisional application No. 60/340,098, filed on Nov. 1, 2001.
(60) Provisional application No. 60/340,097, filed on Nov. 1, 2001.
(60) Provisional application No. 60/340,079, filed on Nov. 1, 2001.

(51) Int. Cl. G06F 17/60

(52) U.S. Cl. 705/2

(57) ABSTRACT

A health care transaction processing system for facilitating information exchange between a health care provider and a plurality of payors is described herein. The system comprises a health care provider computer configured to generate transaction data of a first predefined format. A transaction processing platform, operatively connected to the health care provider computer, serves to (i) convert the transaction data from the first predefined format into a first document formatted consistently with one of a plurality of common data type definitions (DTDs) corresponding to a set of standardized health care transactions, and (ii) translate the first document into a first transaction request document formatted consistently with a second predefined format. The system further includes a first payor computer operatively connected to the transaction processing platform. The first payor computer is associated with a first of the payors and is configured to provide a first transaction response document to the transaction processing platform on the basis of the first transaction request document.

### CROSS-REFERENCE TO RELATED APPLICATIONS

This application claims priority under 35 U.S.C. §119(e) to U.S. Provisional Patent Application No. 60/340,098, filed Nov. 1, 2001, U.S. Provisional Patent Application No. 60/340,097, filed Nov. 1, 2001, and U.S. Provisional Patent Application No. 60/340,079, filed Nov. 1, 2001, each of which is incorporated by reference herein in its entirety.

### FIELD OF THE INVENTION

The present invention relates generally to computerized systems for facilitating the exchange of health care transactional data and related information. More particularly, the present invention relates to a system and method for facilitating the real-time exchange of health care transactional information.

### BACKGROUND OF THE INVENTION

The costs associated with preparing and processing health care data transactions have continued to increase, and it has been estimated that as much as 25% of health care costs are administrative rather than clinical in nature. Previously, submission of information relating to health care transactions (e.g., eligibility verification requests, claims status inquiries) has been done either through the use of paper filings or through the use of proprietary network software. It has been estimated that over 1.6 billion paper-based claims were filed by physicians in 1998.

In order to file claims using paper forms, the patient and health care personnel typically provide a significant amount of data on one or more forms, which is often entered by hand printing or typing. For example, a patient or health care administrative personnel may complete a form or part thereof by entering biographical information (e.g., name, address, date of birth) as well as information relating to the patient's insurance company and existing condition. Administrative personnel may then add information to that form, or another form, further describing the treated condition, describing the procedure or service received by the patient, and describing the individual providing the procedure and other related or supplemental information needed to process and adjudicate the claim.

Following completion of the applicable form, it is mailed either to the insurance company (or other carrier) or to a third party administrator for processing. In either case, upon receipt of the forms the information therein is entered into the computers of the insurance company or third party administrator. After a decision is made as to whether payment for the procedure is appropriate, the amount of any such payment is determined and a check is mailed to the appropriate payee.

The preparation and processing of such paper forms is generally time consuming and tedious, and tends to substantially add to health care costs. Paper forms are also disadvantageous in that errors are often made when the forms are filled out. Errors may arise because, among other things, necessary information may be omitted or mistakes may be made when entering information on the forms. If data is missing from a claim form, it must be returned to its originator, thereby causing delays in the processing of the claim.

Claims have also recently begun to be submitted to third party payors via Electronic Data Interchange (“EDI”) systems. In conventional EDI systems used in support of healthcare transactions, a claim for payment is generated by the healthcare provider or healthcare maintenance organization and transmitted electronically to a clearinghouse that accepts the electronic transmission, edits and processes the transmission, and reroutes and sends the claim electronically to the appropriate third party payors (e.g., insurance companies). The third party payor then adjudicates the claim and furnishes payment or reimbursement, which may occur significantly after service has been rendered. During the claim adjudication process, a claim for payment is processed by the third party payor in order to verify coverage eligibility and the appropriateness of the care and services rendered, as well as to determine the amount of payment or reimbursement. In existing systems, claim adjudication is typically carried out well after the corresponding service has been rendered.

A number of factors have slowed adoption of this type of EDI technology throughout the current healthcare system. These factors include the incompatibility of standards in the commercial insurance and government data systems, concerns relating to the privacy of patient records, and reluctance on the part of physicians to consider new and potentially costly systems. Part of this reluctance stems from the fact that conventional EDI systems have required use of specialized client software installed on physician's computers and used exclusively for electronically submitting claims to a particular clearinghouse. Moreover, these electronic submissions have also typically required the use of dedicated network lines in connection with the submission of claims from the physician's computer to the clearinghouse. As a result, conventional EDI systems have proven to be relatively expensive to use and maintain as software upgrades and other compatibility issues continually require expenditure of funds to maintain pace with changes in technology and claims formatting. Unfortunately, the tendency in the healthcare industry has been to continue to offer products and services reliant upon proprietary claims formats and technology architectures. Since a substantial investment has been made in developing these proprietary systems, both healthcare providers and payors are justifiably reluctant to entertain proposals for new systems which would not leverage the investments made in these proprietary systems. For example, most physicians currently have automated systems for scheduling, billing, claims preparation, forms preparation and accounting. Physicians desire to be able to use these systems to initiate claims, eligibility and authorization transactions. In addition, physicians expect that the results of these transactions should be capable of integration into their existing practice management systems.

The healthcare industry is also now facing the issue of compliance with the Health Insurance Portability and Accountability Act of 1996 (HIPAA), which mandates a set of common standards for electronic transactions. HIPAA has been characterized as the result of efforts to reform healthcare in a way that would streamline industry inefficiencies, reduce paperwork, and make it easier to detect and prosecute fraud and abuse, and enable workers to change jobs even when pre-existing medical conditions. The new standards establish the data sets and formats to be used in submitting eight of the nine transactions specified by HIPAA law: claims/encounters, enrollment and dis-enrollment, eligibility inquiries, payments and remittance advice, premium payments, first reports of injury, status inquiries, referrals, certifications and authorizations. The passage of HIPAA has thus created a significant need in the industry for an open software architecture for healthcare-related transactions which would be compatible with the legacy systems of both payors and providers.

### SUMMARY OF THE INVENTION

In summary, the present invention relates to a health care transaction processing system for facilitating information exchange between a health care provider and a plurality of payors. The system comprises a health care provider computer configured to generate transaction data of a first predefined format. A transaction processing platform, operatively connected to the health care provider computer, serves to (i) convert the transaction data from the first predefined format into a first document formatted consistently with one of a plurality of common data type definitions (DTDs) corresponding to a set of standardized health care transactions, and (ii) translate the first document into a first transaction request document formatted consistently with a second predefined format. The system further includes a first payor computer operatively connected to the transaction processing platform. The first payor computer is associated with a first of the payors and is configured to provide a first transaction response document to the transaction processing platform on the basis of the first transaction request document.

In another aspect, the present invention is directed to a health care transaction processing platform configured to facilitate the exchange of transactional data between health care providers and payors. The health care transaction processing platform includes a web server in communication with a healthcare provider computer. An application server is operatively connected to the web server, and includes a central processing unit and a memory. Included within the memory is an XML processing module operative to convert transaction data received from the health care provider computer in a first predefined format into a first document formatted in accordance with one of a plurality of standardized health care transactions. The memory also stores program instructions for a personalization engine configured to translate the first document into a first transaction request document formatted consistently with a second predefined format. In addition, the memory contains a core application program which may, for example, include an eligibility module and a claim status request module.

In an exemplary embodiment of the invention, the health care transaction-processing system described herein includes a health care transaction-processing platform operative to facilitate the completion of transactions between health care provider computers and payor facilities. The transaction-processing platform may be disposed to communicate with a number of health care provider computers via the Internet through dial-up access, cable modem, satellite uplink or other communications media using the TCP/IP protocol. The payor facilities, and certain other health care provider computers, are preferably interconnected to the transaction-processing platform through dedicated or leased lines forming the physical infrastructure for a virtual private network (“VPN”). Alternately, or for testing or back-up purposes, the transaction-processing platform may also be communicatively coupled to the payor facilities via the Internet. The transaction-processing platform may also be linked to a number of other entities including, for example, hospital systems, pharmacy systems, and lab & clinical systems.

The transaction-processing platform enables the intelligent switching and routing of health care transaction data between payors and health care providers even in the case where the payor and provider databases are mutually incompatible. The payor database may have any of a number of unique or proprietary formats. Although many provider databases are compliant with existing standards, these are typically incompatible with the proprietary formats of the payors. In addition, the practice management systems (PMSs) of the providers also typically use unique data formats, most of which are incompatible with one another. In the exemplary embodiment the system enables communication between payors and providers despite these differing and incompatible data formats by transforming the exchanged health care transaction data into a set of standardized transaction sets. These standardized transaction sets are created in part by using a set of common data type definitions (DTDs). Variation among payors in the information required in connection with each transaction set is accommodated by incorporating differing types of information into optional DTDs utilized in defining a transaction set for a particular payor. This obviates the need to employ differing messaging formats proprietary to each payor, and advantageously permits a common interface specification to be defined by the transaction-processing platform with respect to each payor.

The transaction-processing platform facilitates the electronic filing and processing of health care data transactions submitted through provider computers, as well as the processing of inquiries relating to the status of previously submitted claims. The transaction-processing platform also enables requests for patient eligibility entered though provider computers to be verified by the applicable payor. In this way the transaction-processing platform enables a given health care provider computer to conduct transactions with multiple different payors through a single point of access.

In a particular implementation of the inventive system, health care transaction data is transformed into the XML protocol in order to facilitate interoperability between the legacy systems of a number of different payors and health care providers. This interoperability is achieved by encoding each transaction request and response as an XML-based canonical DTD. Rather than utilizing transaction data encoded in proprietary formats, this implementation of the present invention accommodates variation among the proprietary data formats of various payors using a “translation layer” of code incorporated within optional DTDs isolated and distinct from standardized health care transaction data encoded in the form of canonical XML-based DTDs.

The inventive system preferably defines a separate standardized health transaction interface for each type of health care transaction handled by the transaction-processing platform. This is enabled by the use of canonical DTDs in defining health care transactions, with variation among payors being accommodated by supplementing such canonical DTDs to the extent necessary. For example, HIPAA requires that eligibility of an alleged member of an insured group be capable of verification based upon the Member ID supplied by the alleged member. However, certain payors 16 may desire to verify eligibility based upon other identification parameters (e.g., last name & zip code, or last name & city). In accordance with one aspect of the invention, additional forms of eligibility transactions may be created using canonical and optional DTDs in order to define such additional transaction forms; that is, different combinations of DTDs may be used to define alternate eligibility transactions for various different payors.

In a preferred implementation of the inventive system, different collections of data elements may be used in defining alternate forms of a given health care transaction for various payors. As is discussed below, these differences may be reflected in the user interface provided by the web browser of each provider computer. For example, the web browser may define a screen including a number of data fields through which information for a corresponding number of data elements may be entered. In one embodiment, the browser highlights those data fields required by a given payor in connection with a particular transaction. Similarly, the data fields not utilized by the payor may be “grayed out” or otherwise made inaccessible. For example, in the event a health care transaction associated with a particular payor utilizes “zip code” and “last name” data elements, the web browser would highlight the “zip code” and “last name” fields on the data entry screen displayed for such transaction.

### BRIEF DESCRIPTION OF THE DRAWINGS

Various objects and advantages and a more complete understanding of the present invention are apparent and more readily appreciated by reference to the following Detailed Description and to the appended claims when taken in conjunction with the accompanying Drawings wherein:

FIGS. 1A-1D illustrate a health care transaction processing system in accordance with the present invention.

FIG. 2 depicts provides a more detailed representation of a transaction-processing platform in block diagram form.

FIG. 3 is a block diagram representative of a web server included within the transaction processing platform.

FIG. 4 provides a block diagrammatic representation of an FTP server included within the transaction processing platform.

FIG. 5 provides a block diagrammatic representation of an application server included within the transaction processing platform.

FIG. 6 is a block diagram representative of an exemplary implementation of a health care provider computer.

FIG. 7 illustratively represents the processing flow occurring within the transaction-processing platform during the processing of health care transactions in accordance with the present invention.

FIG. 8 provides an illustrative representation of an exemplary configuration of a metadata repository within the transaction processing platform.

FIG. 9 is a class diagram representative of an exemplary set of interface object relationships established within a health transaction interface of the transaction processing platform.

FIG. 10 provides an illustrative representation of various of the data interchange standards mandated by HIPAA, each of which may be implemented through one or more corresponding health care data transactions facilitated by the system of the present invention.

FIG. 11 provides an illustrative representation of the work flow associated with the eligibility/benefit verification transaction from the perspective of a user of a health care provider computer.

FIG. 12 is a class diagram representative of an eligibility transaction.

FIG. 13 is a sequence diagram representative of the eligibility transaction.

FIG. 14 provides an illustrative representation of the work flow associated with a claim status/inquiry transaction from the perspective of a user of provider computer.

FIG. 15 is a flow chart representative of a store and forward operation performed by the transaction-processing platform.

FIG. 16 is a flow chart illustrating a claim status/inquiry transaction of the present invention.

FIG. 17 is a flow chart illustrating the inventive claim status/inquiry transaction primarily from a user perspective.

FIG. 18 depicts an exemplary claim inquiry search screen configured to identify the data entry fields required in view of selected Patient Type and Search parameters.

FIG. 19 illustratively represents a second search screen presented to a user of a provider computer in the case in which a Subscriber and Date of Service option has been chosen.

FIGS. 20-22 illustratively represent secondary search screens displayed by a requesting provider computer upon selection of various search option criteria.

FIGS. 23-25 depict exemplary claim summary screens generated by a transaction platform of the present invention on the basis of retrieved payor information.

FIG. 26 is a flow chart which provides a simplified representation of user activity associated with an eligibility search transaction of the present invention.

FIG. 27 is a first screen displayed by a requesting provider computer in connection with an eligibility search transaction of the present invention.

FIG. 28 is a second eligibility search screen generated by the transaction processing platform on the basis of the parameter selections made by a requesting user.

FIG. 29 provides a block diagrammatic representation of an alternate embodiment of a health care transaction processing system of the present invention.

### DETAILED DESCRIPTION OF THE INVENTION

### System Overview

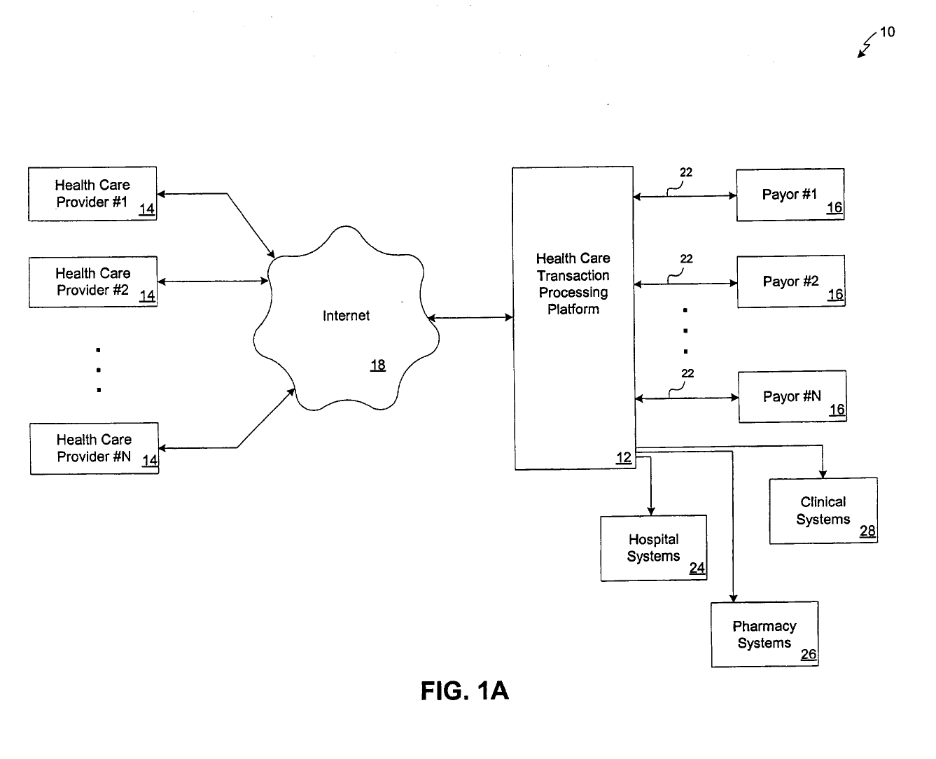

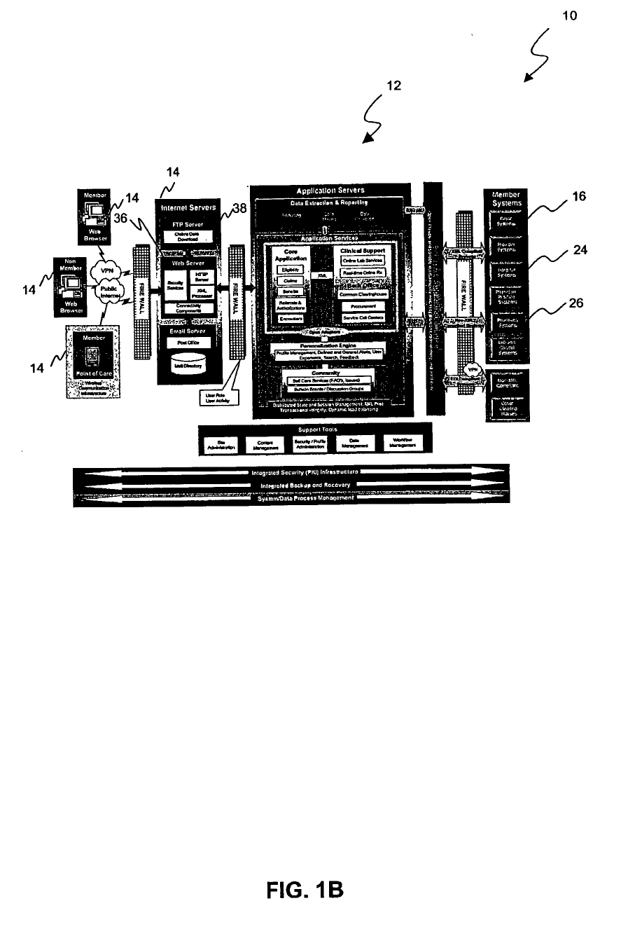

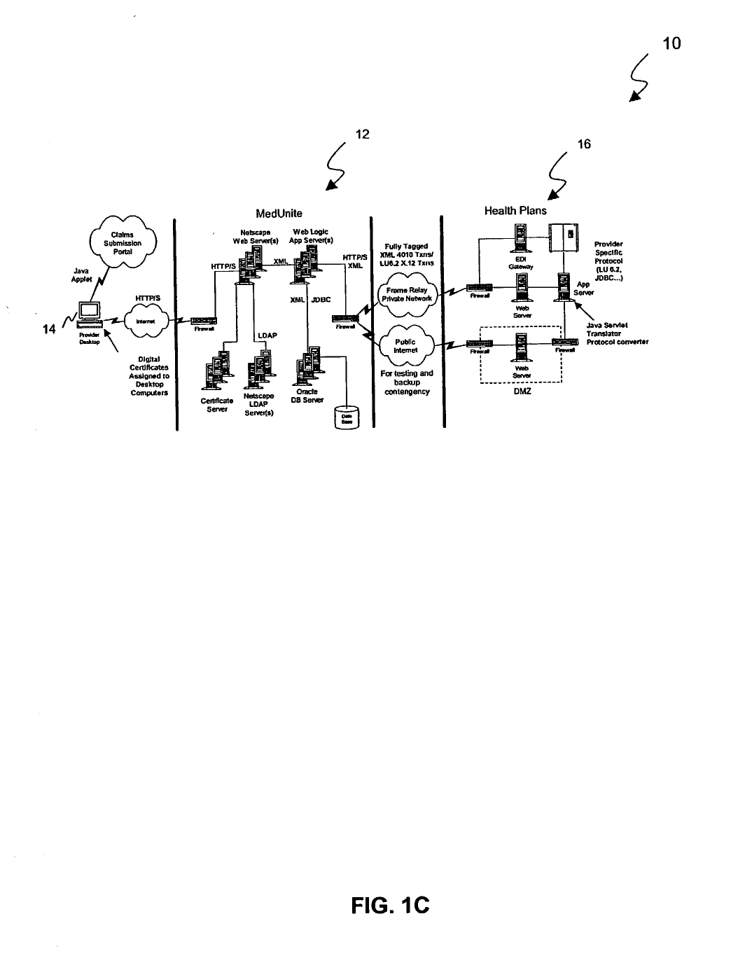

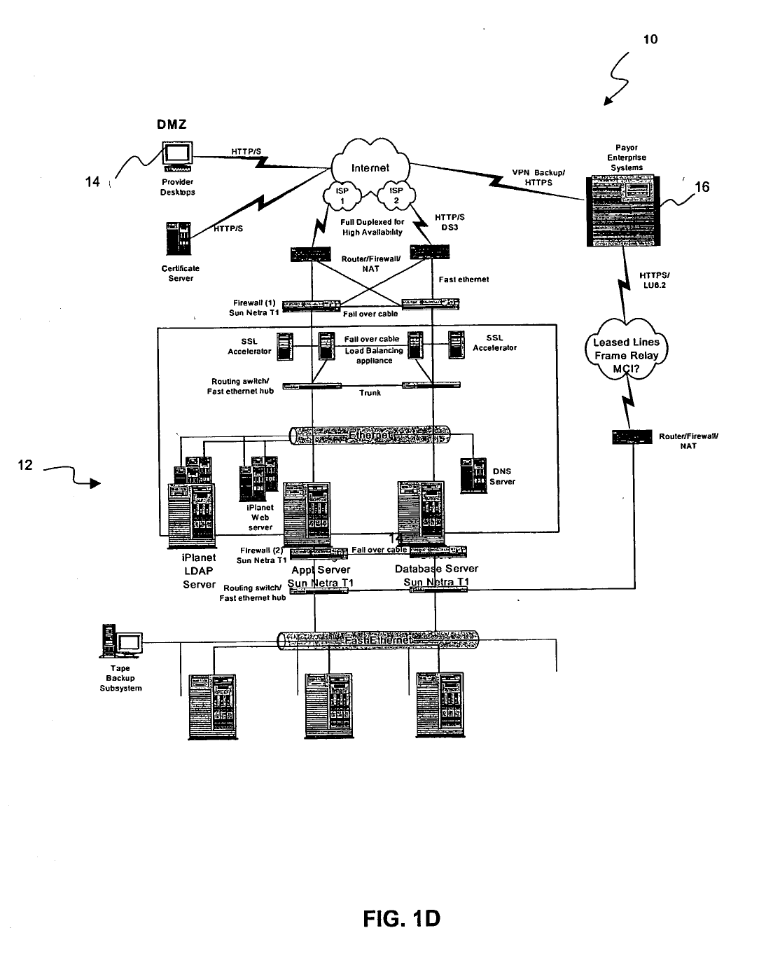

FIGS. 1A-1D illustrate a health care transaction processing system 10 in accordance with the present invention. The system 10 includes a health care transaction-processing platform 12 operative to facilitate the completion of transactions between health care provider computers 14 and payor facilities 16 (hereinafter also respectively referred to as “providers 14” and “payors 16”). As shown, the transaction-processing platform 12 is disposed to communicate with a number of health care provider computers 14 via the Internet 18 through dial-up access, cable modem, satellite uplink or other communications media using the TCP/IP protocol. The payor facilities 16, and certain other health care provider computers 14, are interconnected to the transaction-processing platform 12 preferably through dedicated or leased lines 22 forming the physical infrastructure for a dedicated private network. Alternately, or for testing or back-up purposes, the transaction-processing platform 12 may also be communicatively coupled to the payor facilities 16 via a Virtual Private Network (“VPN”) on the Internet 18. The transaction-processing platform 12 may also be linked to, and facilitate transactions with, a number of other entities such as, for example, hospital systems 24, pharmacy systems 26, and lab & clinical systems 28.

As is described hereinafter, the system and method of the present invention enables the intelligent switching and routing of health care transaction data between payors 16 and health care providers 14 even in the case where the payor and provider databases are mutually incompatible. The payor database may have any of a number of unique or proprietary formats. Although many provider databases are compliant with existing standards, these are typically incompatible with the proprietary formats of the payors. In addition, the practice management systems (PMSs) of the providers also typically use unique data formats, most of which are incompatible with one another. The present invention enables communication between payors and providers despite these differing and incompatible data formats by transforming the exchanged health care transaction data into a set of standardized transaction sets. These standardized transaction sets are created in part by using a set of common data type definitions (DTDs). Variation among payors 16 in the information required in connection with each transaction set is accommodated by incorporating differing sets of data elements into the DTD for the transaction. This obviates the need to employ differing messaging formats proprietary to 9. each payor 16, and advantageously permits a common interface specification to be defined by the transaction-processing platform 12 with respect to each payor 16.

The transaction-processing platform 12 of the present invention facilitates the electronic filing and processing of health care data transactions submitted through provider computers 14. Included among such transactions are, for example, patient eligibility verification, submission of claims, and status inquiries relating to previously submitted claims. In this way the transaction-processing platform 12 enables a given health care provider computer 14 to conduct transactions with multiple different payors 16 through a single point of access.

In accordance with the invention, transactions are accepted and intelligently routed by the transaction-processing platform 12 to the legacy systems of the appropriate payor 16 for substantially real-time response to the requesting provider facility 14. The transaction-processing platform 12 preferably incorporates an intelligent switching and routing architecture based upon XML, thereby allowing for variation in the display of information from different payors 16 within the common look and feel of the user interface of a given provider computer 14. Advantageously, the transaction-processing platform 12 operates without duplicating the processed transaction data within an intermediary database, as is generally required by conventional automated health care processing systems.

### Transaction Processing and Health Care Provider Platforms

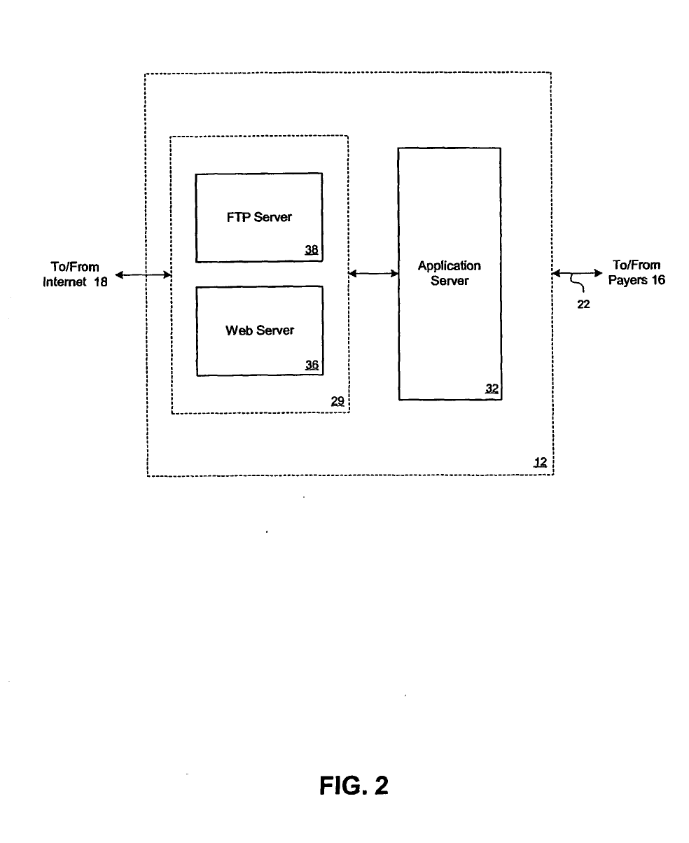

FIG. 2 depicts provides a more detailed representation of the transaction-processing platform 12 in block diagram form. As shown, the transaction-processing platform 12 includes interface servers 29 and an application server 32 in communication therewith. Included among the interface servers 30 is a web server 36 and an FTP server 38. The interface servers 30 and the application server 32 may consist of multiple computers linked to each other via a high-speed network. Alternatively, these servers could reside in a single computer.

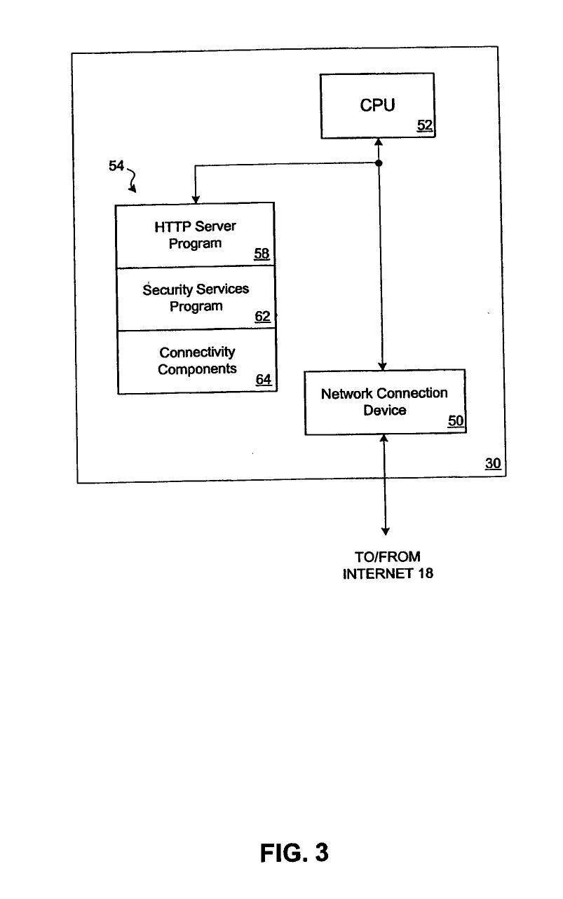

As shown in FIG. 3, the web server 30 includes standard server computer components, including a network connection device 50, a CPU 52, and a memory (primary and/or secondary) 54. The memory 54 stores an HTTP server program 58 to realize standard network communications. The memory 54 also stores a security services program 62 and connectivity components 64. The web server 30 interacts with the health care provider computers 14 via the 10. Internet 18 using the standard hypertext transfer protocol “HTTP” and by sending Hypertext Markup language “HTML” documents.

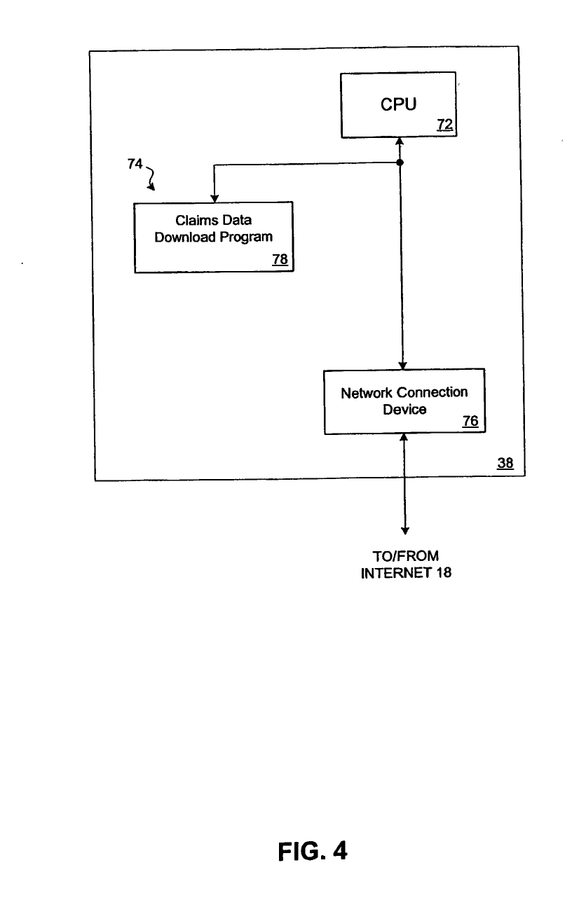

FIG. 4 provides a block diagrammatic representation of the FTP server 38. As shown, the FTP server 38 has a physical configuration similar to that of the web server 30, including a CPU 72, a memory (primary and/or secondary) 74 and a network connection device 76. The memory 74 stores a claims data download program 78.

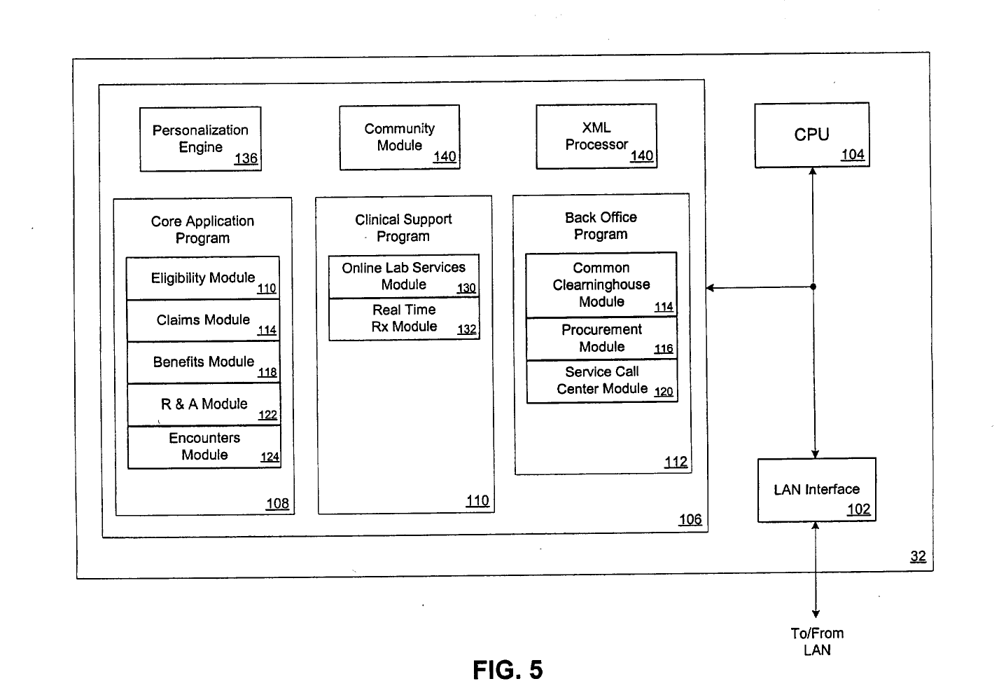

FIG. 5 provides a block diagrammatic representation of the application server 32. As shown, the application server 32 includes a local area network (LAN) interface 102, a CPU 104 and a memory (primary and/or secondary) 106. Within the memory 106 are stored a core application program 108, a clinical support program 110 and a back office program 112, each of which are executed by CPU 104. The core application program 108 includes an eligibility module 110, a claims module 114, a benefits module 118, a referrals & authorizations module 122 and an encounters module 124. Included within the clinical support program 110 are an online lab services module 130 and a real-time online Rx module 132. The back office program 112 includes a common clearinghouse module 114, a procurement module 116 and a service call center module 120. The memory 106 may also include a personalization engine 136, a community module 140 and an XML processor 142.

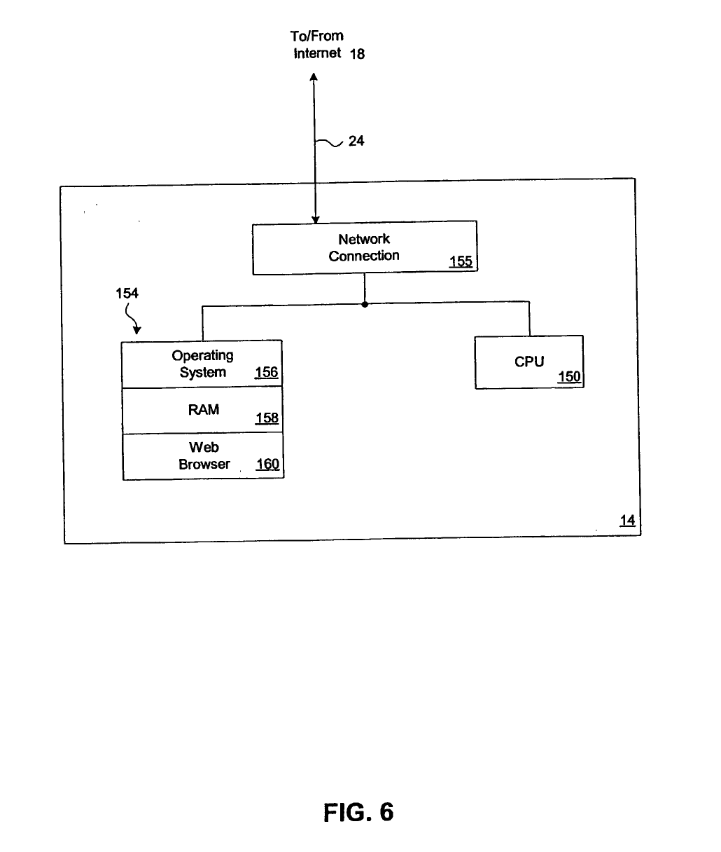

FIG. 6 is a block diagram representative of an exemplary implementation of a health care provider computer 14. As shown, the health care provider computer includes a CPU 150, a memory subsystem 154, and a standard network connection 155. The memory subsystem 154 holds a copy of the operating system 156 for the provider computer 14. Also included within the memory subsystem 34 are RAM 158 and a web browser 160, which executes on the CPU 150 and facilitates communication with the transaction-processing platform 12. Each of the health care provider computers 14 need not have this configuration, and this configuration is intended to be merely illustrative. For example, the health care provider computer 14 may alternatively be a mobile or hand-held device disposed for wireless communication via the Internet 18. The health care provider computer 14 may also be included within a pre-existing practice management system (PMS), which is an application that may be operable on a separate compute (not shown) or on the provider computer 14 itself.

### DETAILED DESCRIPTION OF TRANSACTION PROCESSING

The health care provider computer 14 establishes network communications through a standard network communication device 162. During operation of an exemplary implementation of the system 10, the health care provider computer 14 initiates a request to the transaction-processing platform 12 by sending a web address (i.e., a uniform resource locator or “URL”) that is entered into the web browser 160. The web server 30 of the transaction-processing platform 12 then responds by providing a web page, which is displayed in a window defined by the web browser 160. Connection of the transaction-processing platform 12 to the health care provider computer 14 is initiated by entering a predefined URL (e.g., http://www.medunite.net) into the web browser 160, which is then sent over the Internet 18 to the web server 30 of the transaction-processing platform 12.

Once a connection has been established between the web server 30 and the health care provider computer 14, an introductory sign-in screen is displayed and a user of the computer 14 selects one of the available options (e.g., Practitioner). The system 10 then generates a screen prompting the user to sign-in by entering user identification and password data. The application server 32 then determines whether the entered user identification and password data matches that stored therein. If a match does not exist, the web server 30 generates an error message that is displayed by the web browser 160. When the entered user name and password match the stored identification information, the web browser 160 displays a main page or menu containing a set of various menu options capable of invoking the health care transaction processing of the present invention.

In an exemplary embodiment of the present invention, health care transaction data is transformed into the XML representation in order to facilitate interoperability between the legacy systems of a number of different payors 16 and health care providers. This interoperability is achieved by encoding each transaction request and response as an XML-based canonical DTD. Rather than utilizing transaction data encoded in proprietary formats, the present invention accommodates variation among the proprietary data formats of various using a “translation layer” of code incorporated within optional DTDs isolated and distinct from standardized health care transaction data encoded in the form of canonical XML-based DTDs.

Although the transaction-processing platform 12 operates to handle transactions involving multiple payors 16, the platform 12 permits each transaction result or response to be “branded” and displayed upon a given provider computer 14 in a manner consistent with the branding employed by the applicable payor 16. As is described below, multiple levels of branding may be introduced by the transaction-processing platform 12 through the use of XSL style sheet templates (XSLTs) in accordance with the present invention. In this regard each XML-based transaction response is dynamically converted into an HTML document using the appropriate XSLTs prior to transmission to, and display by, the health care provider computer 14 involved in a transaction with a given payor 16.

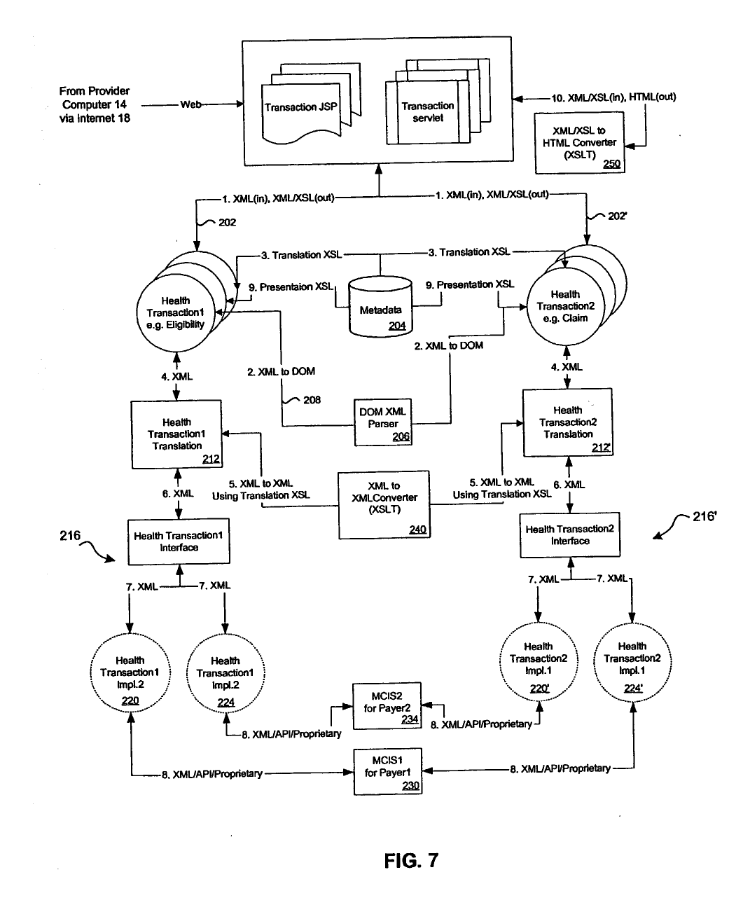

FIG. 7 illustratively represents the processing flow occurring within the transaction-processing platform 12 during the processing of health care transactions in accordance with the present invention. More specifically, FIG. 7 illustratively represents the processing flow occurring with respect to both first and second health care transactions (i.e., “Health Transaction 1” and “Health Transaction 2”). Although the description below is with reference to Health Transaction 1 (e.g., eligibility), identical primed reference numerals are used to identify the corresponding operations of Health Transaction 2 (e.g., claim status).

Referring to FIG. 7, an HTTP request from the web browser 160 relating to a given health care transaction is received by the web server 30 and transformed into an XML document 202 by a transaction servlet or a JSP (Java Server Page). The HTML page responsible for generating the HTTP POST to the transaction servlet should carry sufficient meta-data information to facilitate accurate conversion of the HTTP POST parameters to the XML document 202. A DOM XML parser 206 is then used to create a document object model (“DOM”) representation 208 of the XML request 202. A metadata repository 204 is utilized in identifying and invoking an appropriate translation layer component 212 (e.g., eligibility) to operate upon the DOM representation 208. That is, the translation layer component 212 defines a translation specification that is applied to the DOM representation 208 in order to create a transaction request document formatted consistently with the system of the payor 16 participating in the transaction. The translation layer component 212 also binds to a health transaction interface 216 associated with the transaction being processed (e.g., eligibility) and invokes a predefined interface used in interfacing with the appropriate payor 16.

In accordance with the invention, a separate standardized health transaction interface 216 is created for each type of health care transaction handled by the transaction-processing platform 12. This is enabled by the use of canonical DTDs in defining health care transactions, with 13. variation among payors 16 being accommodated by supplementing such canonical DTDs to the extent necessary. For example, HIPAA requires that eligibility of an alleged member of an insured group be capable of verification based upon the Member ID supplied by the alleged member. However, certain payors 16 may desire to verify eligibility based upon other identification parameters (e.g., last name & zip code, or last name & city). In accordance with the invention, additional forms of eligibility transactions may be created using canonical and optional DTDs in order to define such additional transaction forms; that is, different combinations of DTDs may be used to define alternate eligibility transactions for various different payors 16.

Although a different standardized interface 216 is used for each transaction, an implementation of each standardized interface is created in accordance with the characteristics of each of the legacy systems of the payors 16. For example, a first implementation 220 of the interface 216 is provided for a first of the payors 16, while a second implementation 224 of interface 216 is provided for a second of the payors 16. As shown, the first interface implementation 220 functions to extract the information necessary to complete the subject health care transaction from the legacy systems 230 of the first payor 16, while the second interface implementation 224 functions to extract the necessary information from the legacy systems 234 of the second payor 16. The interface implementations 220 and 224 extract such necessary information using operations denominated in the protocol of the legacy systems 230 and 234, respectively. For example, if the legacy system 220 is operative in accordance with the COBOL protocol, then the first interface implementation 220 will execute the COBOL operations and procedures required to retrieve the necessary information. In the exemplary embodiment the interface 216 may be implemented as an RMI Server capable of accepting simultaneous requests for transactions involving multiple payors 16.

Once the necessary information has been extracted from the legacy systems of the payors 16, it is necessary to transform the information into a form intelligible to the system of the requesting provider computer 14. In the exemplary embodiment this transformation occurs in two steps. First, the retrieved information is converted from the protocol of the applicable legacy system into XML. Second, the resultant XML document is converted into an HTML document formatted and branded consistently with the system of the requesting provider computer 14. Such branding may be effected in multiple levels consistent with the branding process described above.

Referring again to FIG. 7, the interface 216 functions to convert the information retrieved from the legacy system of the applicable payor 16 into a retrieved XML document. Based upon the metadata 204 associated with the HTTP POST operation used to convey the initial transaction data from the requesting provider computer 14, an appropriate XSLT 240 is selected for application to the retrieved XML document. An HTML converter 250 then operates to transform, using the selected XSLT, the retrieved XML document into an HTML document formatted and branded consistently with the system of the provider computer 14. In an exemplary embodiment the converter 250 is realized using an Oracle XDK toolkit, which includes an XML parser (version V2) and an integrated XSLT processor.

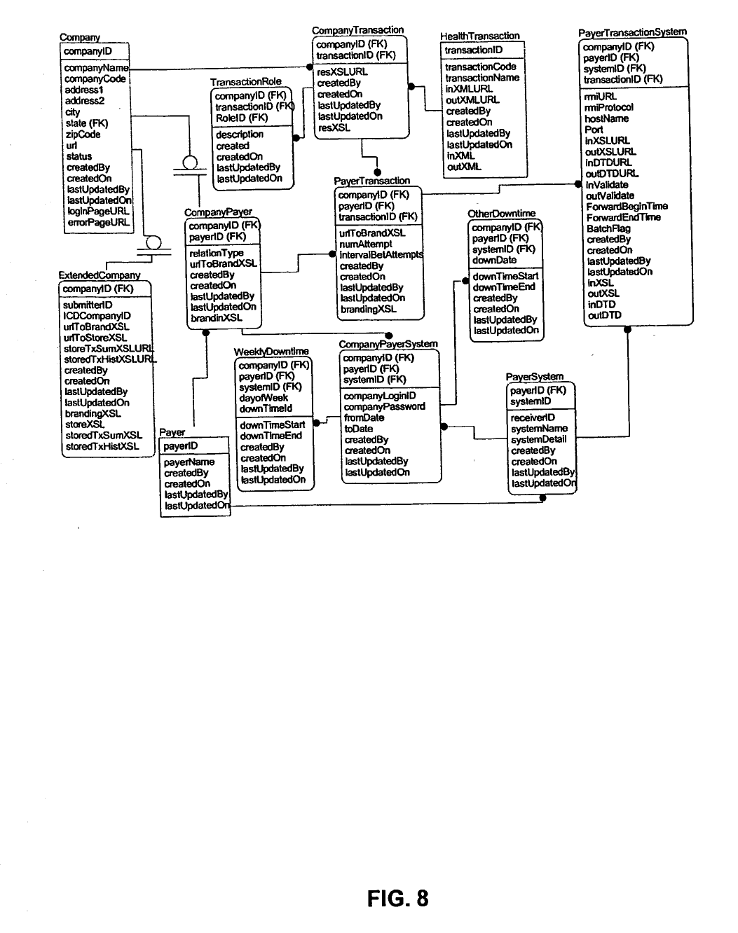

FIG. 8 provides an illustrative representation of an exemplary configuration of the metadata repository 204. As shown, FIG. 8 depicts the interrelationship between a plurality of metadata record types such as, for example, Company, Payor Transaction, Health Transaction, and Company Transaction record types. Records of a given type are indexed, and may be accessed, as a function of predefined identification fields. For example, CQmpany record types are indexed as a function a companyID field and records of type PayorSystem are indexed as function of PayorID and system ID.

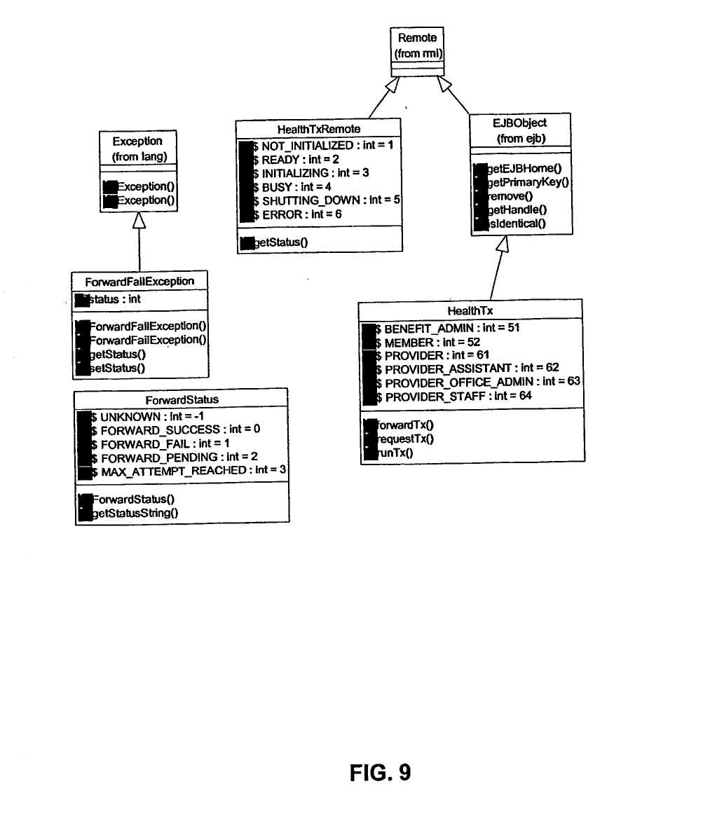

FIG. 9 is a class diagram representative of an exemplary set of interface object relationships established within the health transaction interface 216. The interfaces represented within FIG. 9 define the operations of accepting a health care transaction request, executing the request by accessing the legacy system of the applicable payor 16, and responding to the request through generation of a response XML document incorporating the information received from such legacy system. In an exemplary embodiment the runTx( ) method of the HealthTx interface object accepts two arguments: (1) an XML-based transaction request generated in the manner described above with respect to FIG. 8, and (2) an application context indication. The runTx( ) method returns a vector comprised of the response XML document, a response XSL, and a URL to DTD of the response XML document.

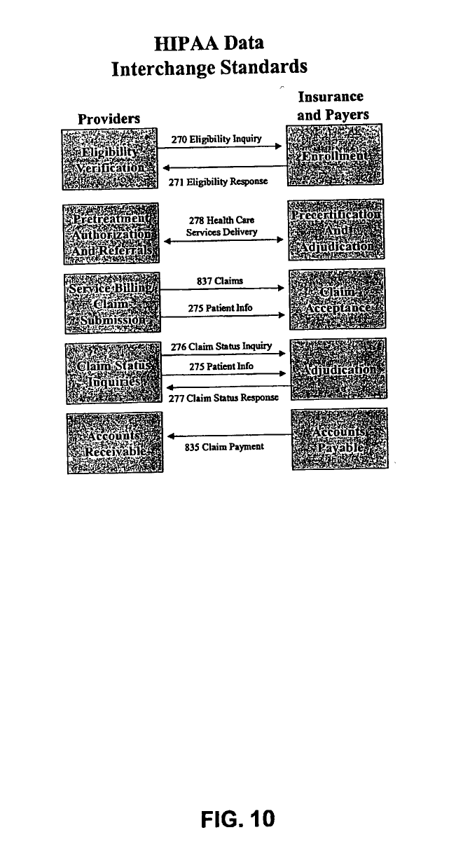

FIG. 10 provides an illustrative representation of various of the data interchange standards mandated by HIPAA, each of which may be implemented through one or more corresponding health care data transactions facilitated by the system 10 of the present invention. These health care data transaction services may be characterized as eligibility/benefit verification and enrollment, referral and authorization, claims submission and real-time claims adjudication, claims status and inquires, and electronic remittance.

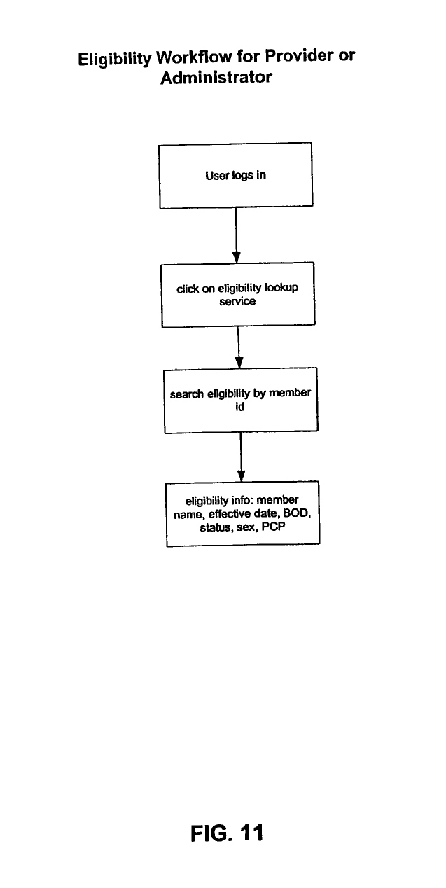

FIG. 11 provides an illustrative representation of the work flow associated with the eligibility/benefit verification transaction from the perspective of a user of provider computer 14. The eligibility/benefit verification transaction allows a request to be submitted through a provider computer 14 for verification of patient eligibility status. Responses to this request from the applicable payor 16 will typically include, at a minimum, validation of the request, patient demographics, member and subscriber ID, effective/termination dates of eligibility, and office co-payment information.

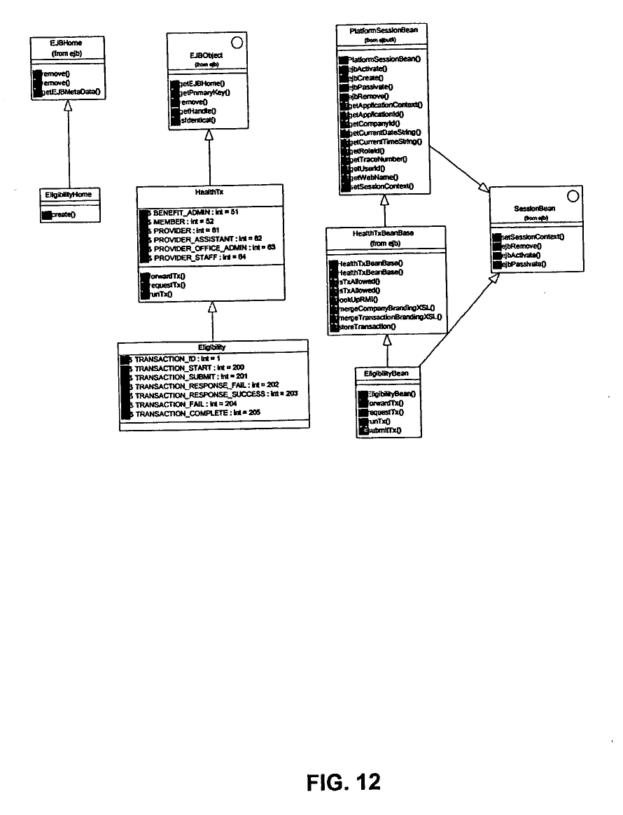

FIG. 12 is a class diagram representative of the eligibility transaction. Although the class diagram of FIG. 12 specifically relates to the eligibility transaction, in a preferred embodiment each of the health care transactions is handled by the transaction-processing platform 12. In this regard a session bean corresponding to each transaction typically implements both a home interface and a remote interface. The session bean is generally extended into three levels, one of which is used to characterize property specific to the platform 12. The other levels of the session bean relate to health transaction property and eligibility specific property. Each remote interface is also extended into two levels: a health transaction specific interface (HealthTx) and an eligibility specific interface (Eligibility).

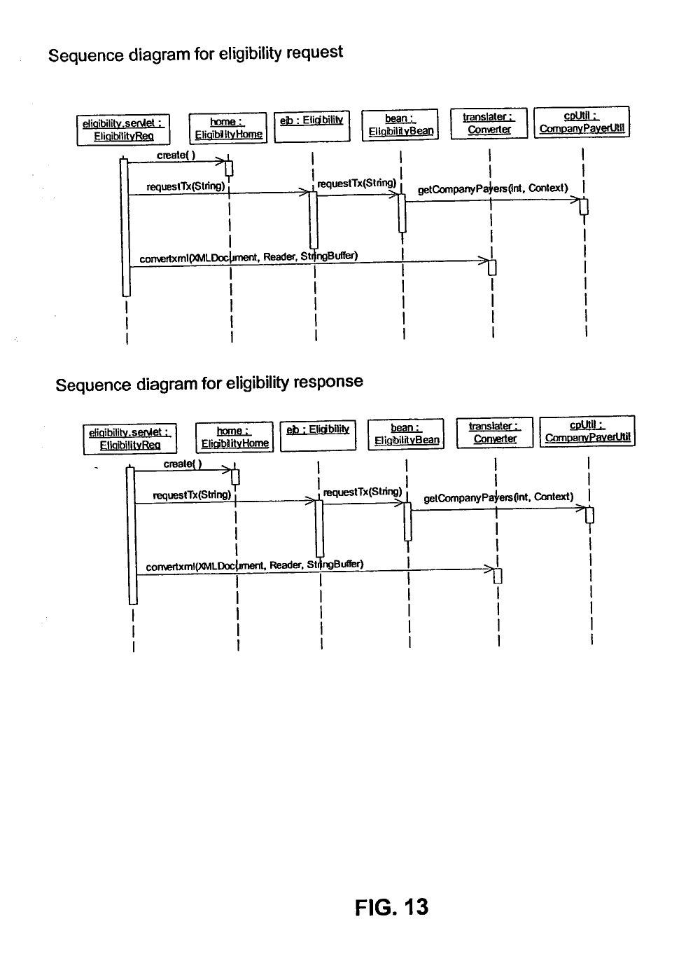

FIG. 13 is a sequence diagram representative of the eligibility transaction. As shown, the sequence diagram illustrates the interrelationship between object classes employed by the transaction-processing platform 12 and external object classes utilized by providers 14 and payors 16.

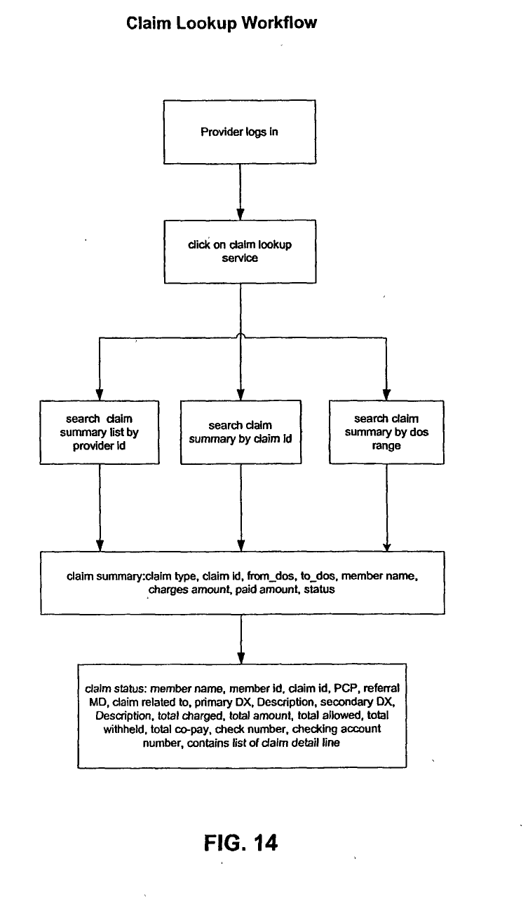

FIG. 14 provides an illustrative representation of the work flow associated with the claim status/inquiry transaction from the perspective of a user of provider computer 14. The claim status/inquiry transaction permits the submission of requests via provider computers 14 regarding the status of a previously submitted claim. Responses from the applicable payor 16 will include an indicator of receipt, and the disposition or status of the claim in the adjudication system of the payor 16.

The referrals/authorization transaction enables a request to be submitted through a provider computer 14 for authorization to perform procedures through the system 10 for 16. transmission to a payor 16. The requesting provider computer 14 will receive validation and other reports indicating the status of the authorization request as it is routed by the transaction processing platform 12 to the payor 16. Responses will include an approval with an authorization number, a request for additional information, or a denial. This transaction will typically begin with specialty care referrals and pre-certification for institutional services.

The claims submission transaction allows claims to be submitted through a provider computer 14 for intelligent routing through the transaction-processing platform 12 to the applicable payor 16. The transaction-processing platform 12 will furnish the requesting provider computer 14 with validation and other reports indicating the status of the applicable claim(s) during routing to the applicable payor 16. Replies from the payor 16 that are generated in response to the submission of a claim to either acknowledge its receipt or to report an error in the claim will be made available to the submitting provider computer 14.

The present invention also contemplates use of an encounter transaction, in which encounter information is submitted by the computers 14 of health care providers that either posses or have been delegated certain claim payment or other applicable administrative functions. Encounters are submitted via provider computers 14 for intelligent routing by the transaction-processing platform 12 to the appropriate payor 16. The requesting provider computer 14 will receive validation and other reports from the platform 12 indicating the status of each encounter as it is routed to the payor 16. Replies from the payor 16 generated in response to the submission of an encounter which either acknowledge receipt of a given claim and/or report an error in the claim are made available to the provider computer 14.

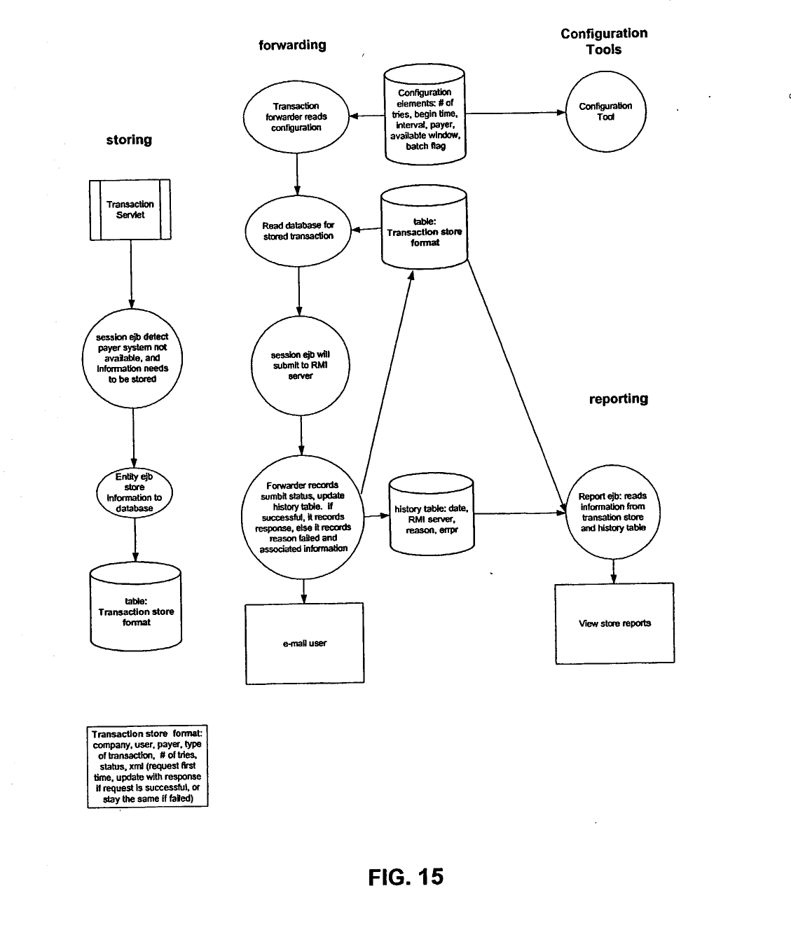

FIG. 15 is a flow chart representative of a store and forward operation performed by the transaction-processing platform 12. As described above, the transaction-processing platform 12 is operative to transform a health care transaction request received from a health care provider computer 14 into an XML-based request. The transaction-processing platform 12 then routes the request to the applicable payor 16 and attempts to complete the transaction with such payor 16. In the event the systems of the payor 16 are unavailable, the transaction-processing platform 12 executes a transaction local store and forward operation in the manner represented by FIG. 15. As shown, a store component of the operation functions to detect whether the system of applicable payor 16 is available. In the case of unavailability, the data relating to the transaction is stored within the transaction-processing platform 12. A transaction forwarder then determines a current configuration state of the store and forward operation. This configuration may be based upon, for example, the number of previous attempts to access the system of the payor 16, the time of the initial of such attempts, the duration of a predefined interval between attempts, and an availability window associated with the payor 16. The transaction forwarder then reads the stored transaction data and, based upon the current configuration, selects a time to attempt submission of the transaction. If the submission is successful, the response to the request is recorded; otherwise, the reason for the unsuccessful attempt is recorded along with any associated information.

As described above, different collections of data elements may be used in defining alternate forms of a given health care transaction for various payors 16. In accordance with the invention, these differences may be reflected in the user interface provided by the web browser 160 of each provider computer 14. For example, the web browser 160 may define a screen including a number of data fields through which information for a corresponding number of data elements may be entered. In one embodiment, the browser 160 highlights those data fields required by a given payor 16 in connection with a particular transaction. Similarly, the data fields not utilized by the payor 16 may be “grayed out” or otherwise made inaccessible. For example, in the event a health care transaction associated with a particular payor 16 utilizes “zip code” and “last name” data elements, the web browser 160 would highlight the “zip code” and “last name” fields on the data entry screen displayed for such transaction.

### Claim Status Inquiry Transaction

As mentioned above, the claim status/inquiry transaction permits the submission of requests via provider computers 14 regarding the status of a previously submitted claim. Responses from the applicable payor 16 will include an indicator of receipt, and the disposition or status of the claim in the adjudication system of the payor 16. Conventionally, claim status inquiries required interested parties (e.g., practice administrators or provider users) to either obtain such information telephonically or by accessing a number of Internet-based portals specific to various payors. By unifying multiple payors and functionality into a single portal, the present invention improve this standard approach.

The claim status/inquiry transaction of the present invention enables users to be able to check on the status of previously filed claims across multiple payor platforms. This function will allow users to view basic claim information on an individual basis, including but not limited to: whether the claim has been paid/denied; how much of the claim was or was not covered; and the date the claim was paid.

In an exemplary embodiment, a claim status inquiry icon will be present on the “homepage” generated by the transaction processing platform 12 and transmitted to the requesting provider computer 14. As is described below, when this icon is selected the resulting screen transmitted to the requesting provider computer 14 will have a number of drop down boxes specifying the patient, payor, the relationship to the subscriber, and the claim search preference (claim number or dates of service). This screen will be followed by an additional screen, which will require dates of service or claim number, depending on which preference was previously selected.

Once all search criteria has been entered and submitted, the transaction processing platform 12 responds by transmitting a claim summary screen to the requesting provider computer 14. The claim summary page will display all claims that matched the submitted claim criteria. From this screen, the user will be able to select a particular claim item and drill down to extract further claim information.

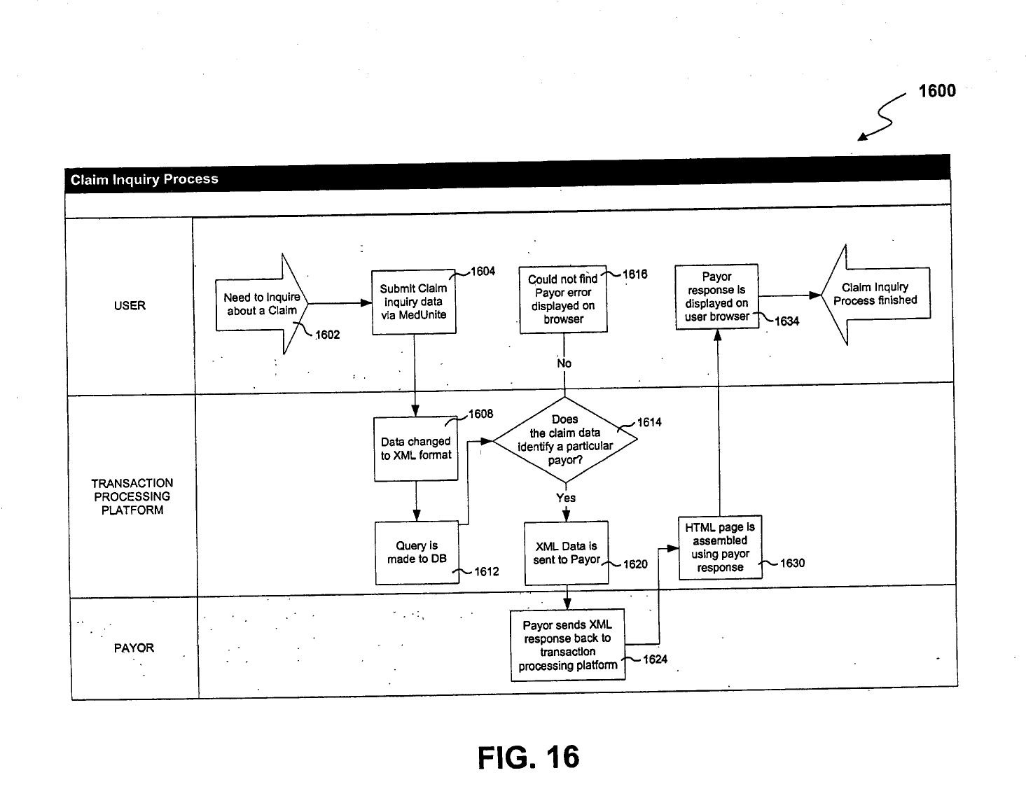

Turning now to FIG. 16, there is provided a flow chart 1600 illustrating the inventive claim status/inquiry transaction. The process begins upon determining that it is necessary or desired to check the status of a pending claim (step 1602). Using various claim inquiry screens (described below) transmitted by the transaction platform 12 to the applicable provider computer 14, in a step 1604 the user submits search criteria (e.g., dates of service or claim number). Once the search criteria submitted by user is received at the transaction processing platform 12, it is transformed into an XML format in the manner described above (step 1608). A query is then made to the metadata database 204 on the basis of the XML-based search criteria in order to determine which payor 16 has been was requested (step 1612). If a payor 16 is not able to be identified (step 1614), an error screen is transmitted to the provider computer 14 (step 1616). Otherwise, the XML-based search criteria is sent to the payor 16 identified by the information returned by the database 204 (step 1620). The payor 16 then processes the search criteria and returns a response to the transaction processing platform (step 1624). Finally, the transaction processing platform 12 assembles an HTML page using this response (step 1630) and transmits it to the requesting provider computer 14 (step 1634).

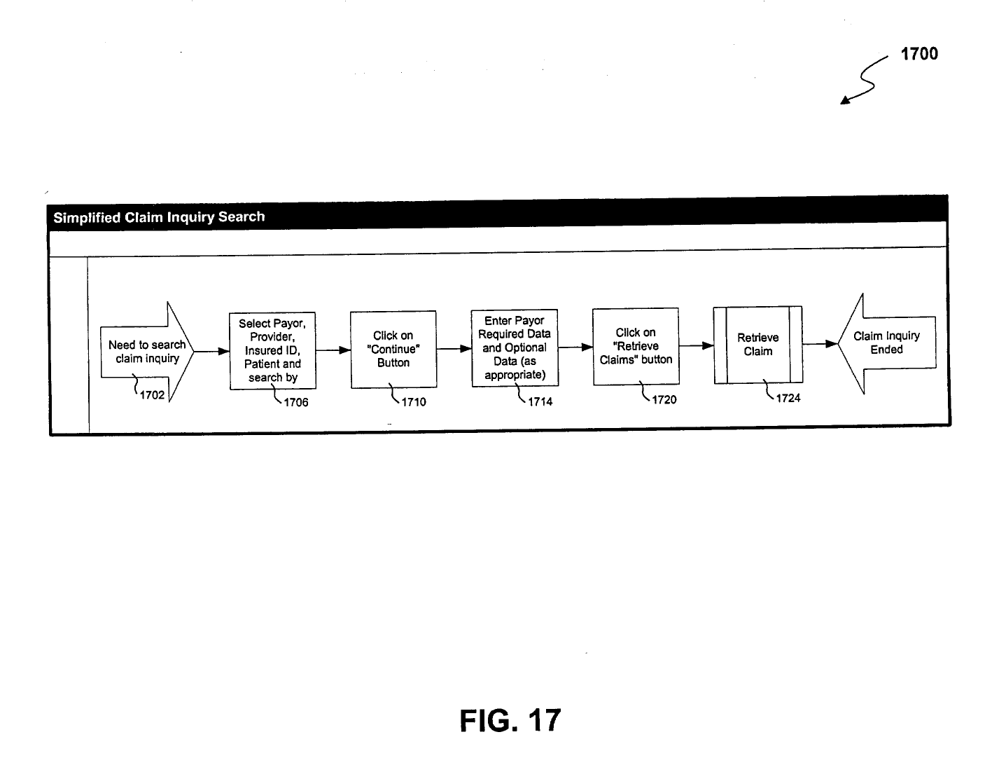

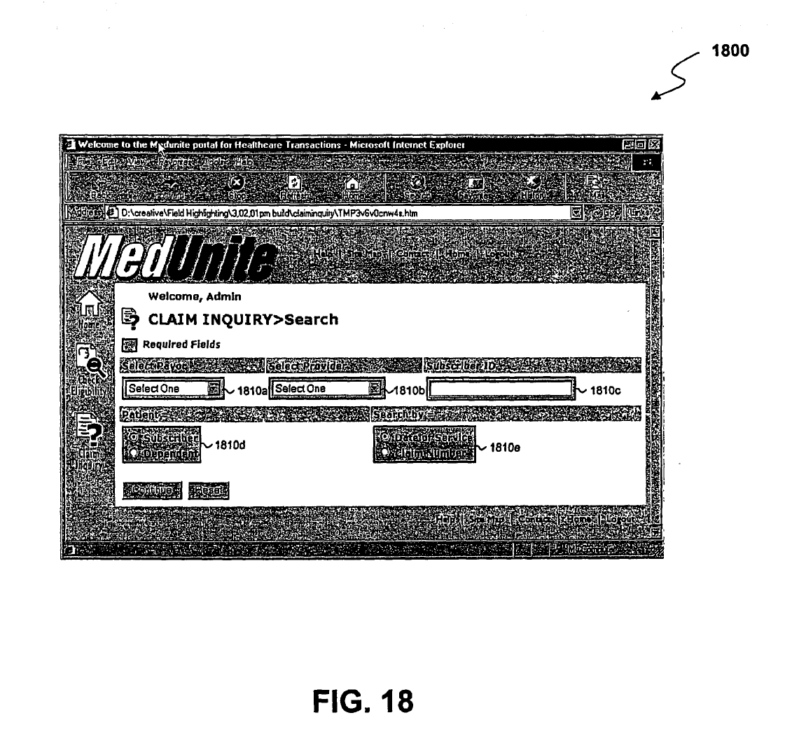

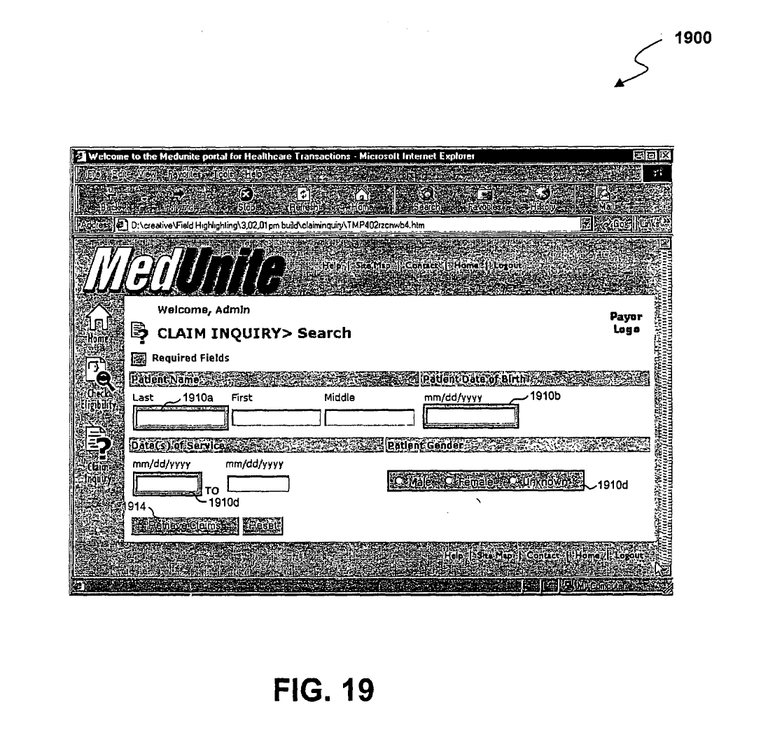

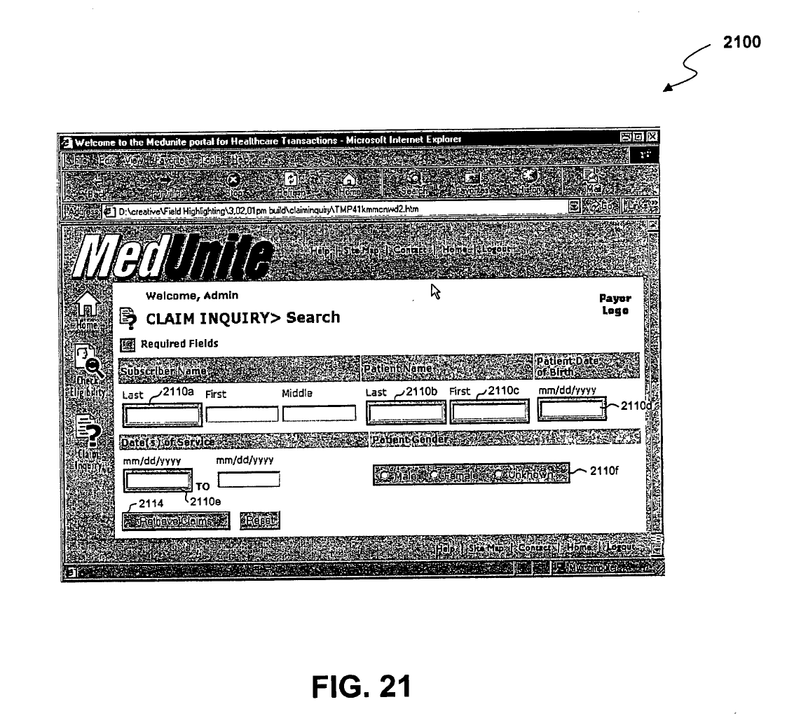

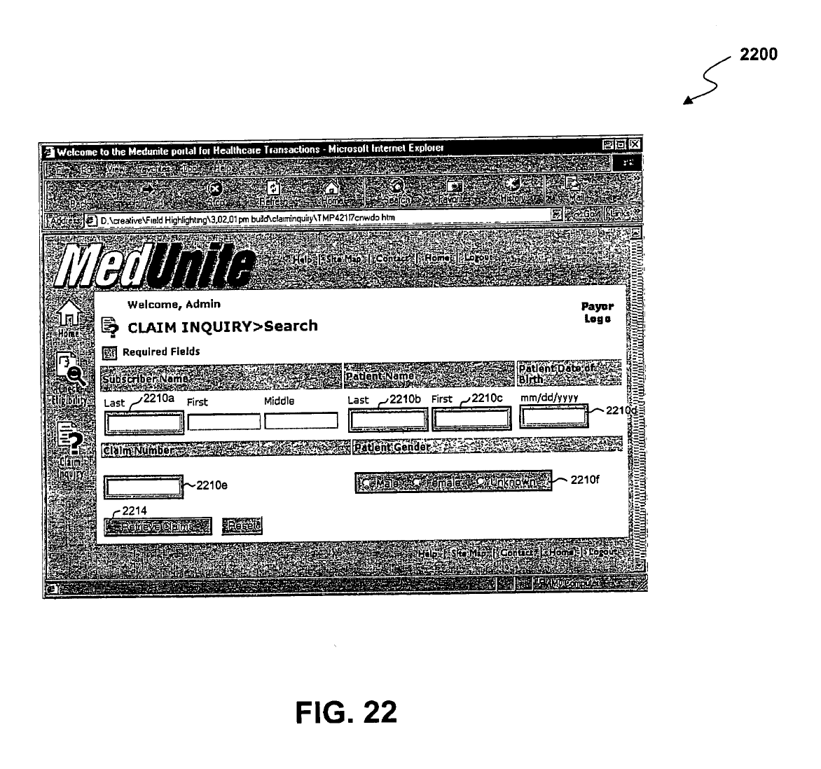

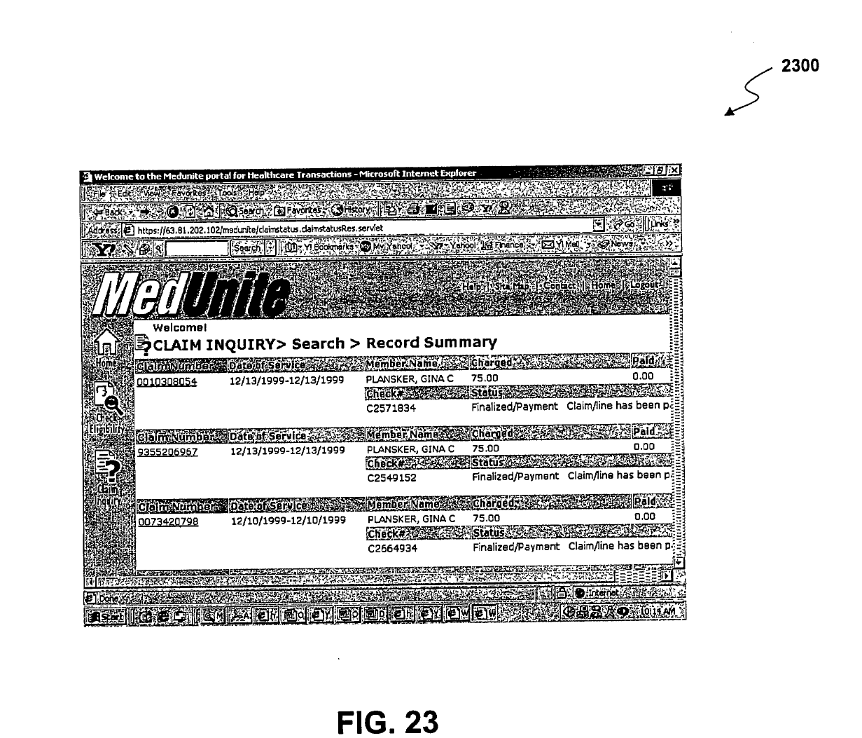

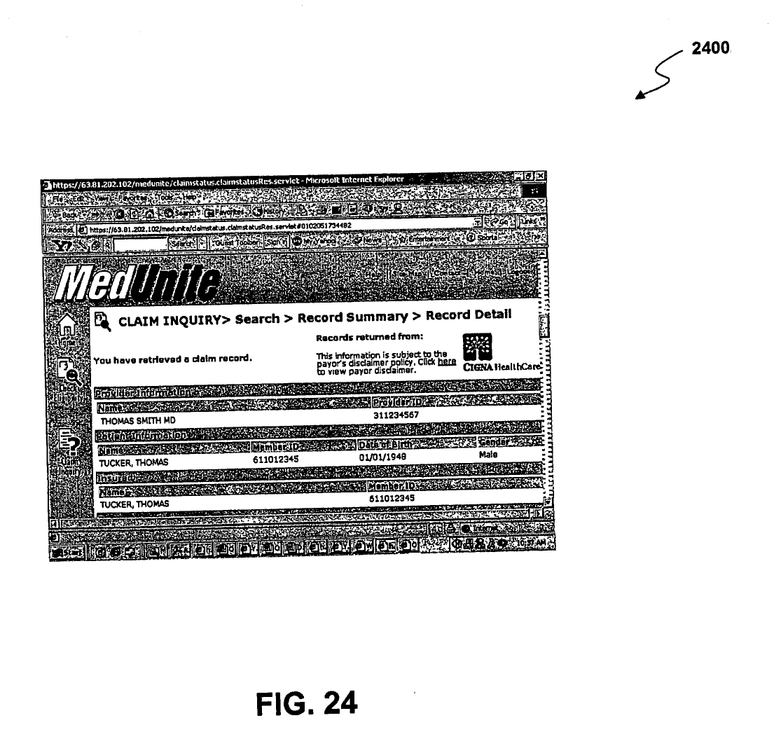

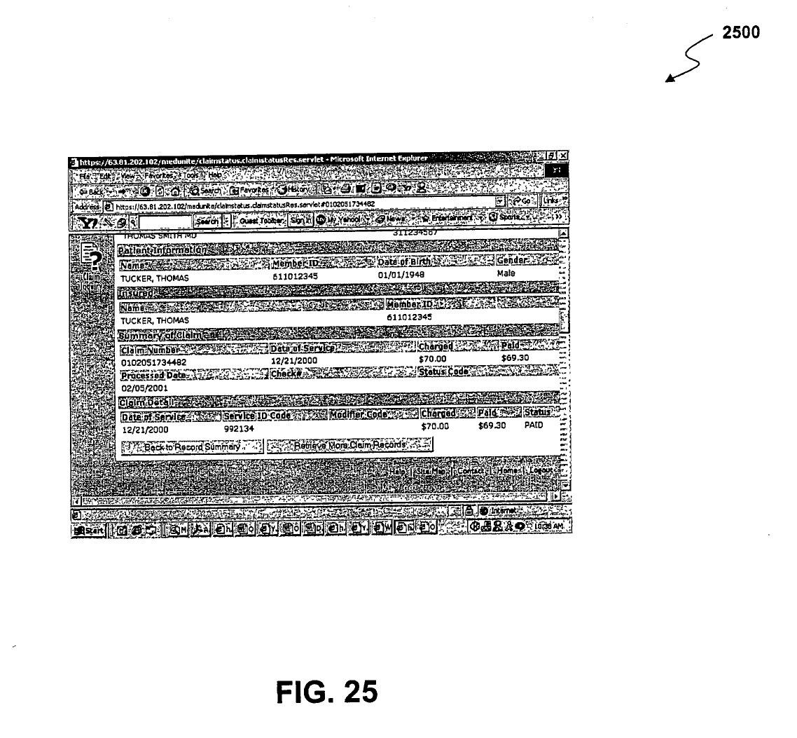

FIG. 17 is a flow chart 1700 which illustrates the inventive claim status/inquiry transaction primarily from a user perspective. As shown, in a step 1702 the user determines that it is necessary or desirable to check the status of a pending claim. This could be undertaken in order to determine, for example, an amount charged or paid in connection with a given claim, or other claim status information. The user then enters data which identifies, for example, a payor, provider, insured ID, and Search By fields as required by the screen (FIG. 18) transmitted by the transaction platform 12 to the applicable provider computer 14 (step 1706). The user then points and clicks on a “continue button” 1804 or the like to advance to a second claim inquiry search screen (step 1710). An exemplary set of such second claim inquiry search screens are depicted in FIGS. 19-22. Based upon the Patient and Search By fields selected, various required fields 1910, 2010, 2110, 2210 will be highlighted in this second search screen (e.g., last name, patient date of birth, patient gender, and either date(s) of service or claim number fields). The user then enters the required patient information into the highlighted fields 1910, 2010, 2110, 2210 (step 1714). Next, the user submits the search data via selection of a “Retrieve claims” button 1914, 2014, 2114, 2214 located on the applicable claim inquiry search screen (step 1720). In response, the transaction platform 12 effects a claim inquiry function pursuant to which information is retrieved from the applicable payor 16 using the mechanics described above with reference to FIG. 7 (step 1724). A claim summary screen may then be generated by the transaction platform 12 on the basis of the retrieved payor information and transmitted to the requesting provider computer 14. FIGS. 23-25 depict exemplary claim summary screens 2300, 2400 and 2500, respectively.

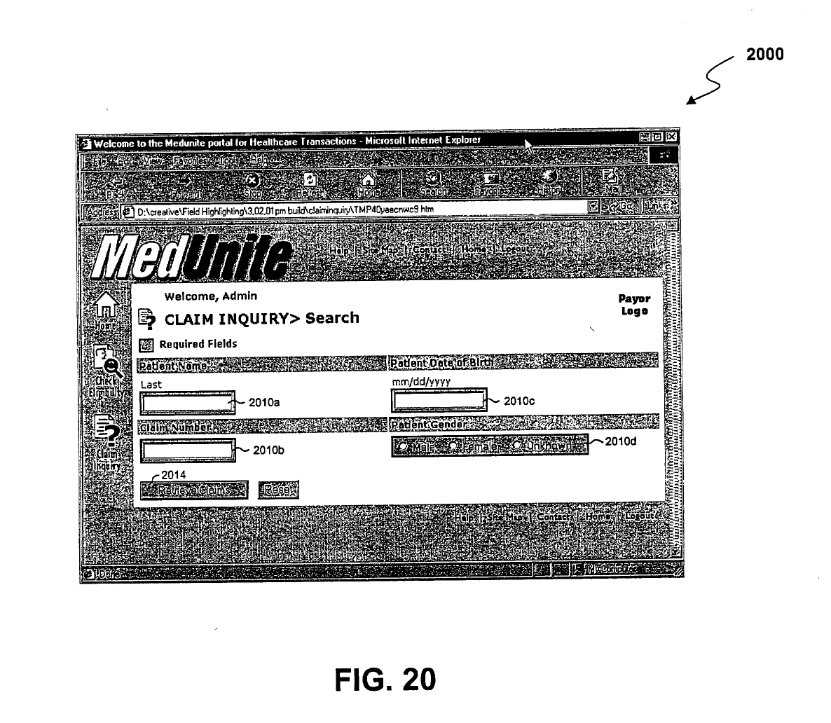

FIG. 18 depicts an exemplary claim inquiry search screen 1800 configured to identify the data entry fields 1810 required in view of a selected Patient Type (e.g., subscriber or dependant) and Search (e.g., date of service or claim number) parameters. The required fields 1810 will preferably be highlighted (e.g., through the use of colored borders), thereby aiding users of provider computers 14 in navigating through the required fields. In the exemplary embodiment a number of combinations of search criteria may be used to conduct a claim inquiry search via the search screens generated by the transaction processing platform and transmitted to the requesting provider computer 14. Although FIG. 18 depicts the case in which the Subscriber and Date of Service option has been selected, other search criteria are possible as well; namely, Subscriber and claim Number, Dependant and Date of Service, and Dependant and claim Number. Similarly, FIG. 19 illustratively represents the second search screen presented to a user of a provider computer 14 in the case in which the Subscriber and Date of Service option has been chosen and the user has advanced by selecting the “Continue” button 1804 (FIG. 18). In like manner FIGS. 20-22 illustratively represent the second search screens displayed by the requesting provider computer 14 upon selection of the other search option criteria; namely, the Subscriber and claim Number, Dependant and Date of Service, and Dependant and claim Number options, respectively. In each case the user of the requesting provider computer 14 enters information into the highlighted fields corresponding to the selected search option.

Table I and Table II provide tabular listings of exemplary set of required fields supplied by payors 16 in response to claim inquiry transactions predicated upon Subscriber and Dependant search queries, respectively.

TABLE I

| | Required/Situational |
|---|---|
| Record Summary | per HIPPA |
| Claim Number | Required |
| Date of Service | Situational |
| | Last Name: Req |
| Member Name | First Name: Sit |
| Charged | Required |
| Paid | Required |
| Check Issue Date | Situational |
| Processed Date | Situational |
| Check # | Situational |
| Status | Required |
| Claim Status | Not HIPPA Compliant |
| Record Detail | |
| Provider Name | Last Name or Org. Name is Req. |
| Provider ID | Required |
| | Last Name: Req |
| Patient Name | First Name: Sit |
| Patient ID | Required |
| Date of Birth | Required |
| Gender | Required |
| | Last Name: Req |
| Insured Name | First Name: Sit |
| Insured ID | Required |
| Summary of Claim | |
| Claim Number | Required |
| Date of Service | Situational |
| Charged | Required |
| Paid | Required |
| Check Issue Date | Situational |
| Processed Date | Situational |
| Check # | Situational |
| Status | Required |
| Claims Status | Situational |
| Claim Detail | |
| Date of Service | Situational |
| Service ID Code | Situational |
| Quantity | Situational |
| Charged | Required |
| Paid | Required |
| Status | Required |
| Claims Status | Not HIPPA Compliant |

TABLE II

| | Required/Situational |
|---|---|
| Record Summary | per HIPPA |
| Claim Number | Required |
| Date of Service | Situational |
| | Last Name: Req |
| Member Name | First Name: Sit |
| Charged | Required |
| Paid | Required |
| Check Issue Date | Situational |
| Processed Date | Situational |
| Check # | Situational |
| Status | Required |
| Claim Status | Not HIPPA Compliant |
| Record Detail | |
| | Last Name or |
| Provider Name | Org. Name is Req. |
| Provider ID | Required |
| | Last Name: Req |
| Patient Name | First Name: Sit |
| Patient ID | Required |
| Date of Birth | Required |
| Gender | Required |
| | Last Name: Req |
| Insured Name | First Name: Sit |
| Insured ID | Required |
| Summary of Claim | |
| Claim Number | Required |
| Date of Service | Situational |
| Charged | Required |
| Paid | Required |
| Check Issue Date | Situational |
| Processed Date | Situational |
| Check # | Situational |
| Status | Required |
| Claims Status | Situational |
| Date of Service | Situational |
| Service ID Code | Situational |
| Quantity | Situational |
| Charged | Required |
| Paid | Required |
| Status | Required |
| Claims Status | Not HIPPA Compliant |

The above-referenced provisional application Serial No. 60/340,097 contains a Professional Implementation Guide consistent with ANSI ASC X12 Health Care claim Status Request (276) and the ANSI ASC X12 Health Care claim Status Response (277) Professional Implementation Guide. The Implementation Guide was developed based on exemplary payor processing requirements and the 276/277 Professional transaction format requirements. The Implementation Guide focuses on the use of the 276 Health Care claim Status Request transaction format in requesting the status of a health care claim(s), and on the use of the 277 Health Care claim Status Response transaction format in responding with the information regarding the specified claim(s). In particular, the Implementation Guide defines uniform data content, identifies valid code tables, and specifies values applicable to the 276 Health Care claim Status Request and the 277 Health Care claim Status Response.

The claim Status Inquiry transaction described in the above Implementation Guide will enable users of provider computers 14 to be able to check on the status of previously filed claims across multiple payor platforms. This function will allow such users to view basic claim information on an individual basis, including but not limited to: whether the claim has been paid/denied; how much of the claim was or was not covered; and the date the claim was paid. This above-referenced provisional application Serial No. 60/340,097 further includes exemplary DTDs consistent with the ANSI ASC X12 276/277 format requirements capable of being utilized by the transaction processing platform 12.

### Health Care Eligibility Transaction

The eligibility inquiry transaction of the present invention enables physicians and practice administrators to verify or discount a patient's benefit eligibility on a substantially real-time basis. The exemplary implementation of the eligibility inquiry transaction described herein involve is made accessible to users of a requesting provider computer 14 through a set of eligibility search/eligibility response screens described herein. The inventive eligibility search process provides a mechanism for specifically correlating required search screen data entry fields to selected Patient Types and payors 16. The required fields will be highlighted on the search screens, thereby assisting users of provider computers 14 in navigating through the fields required by a particular Patient Type and payor 16.

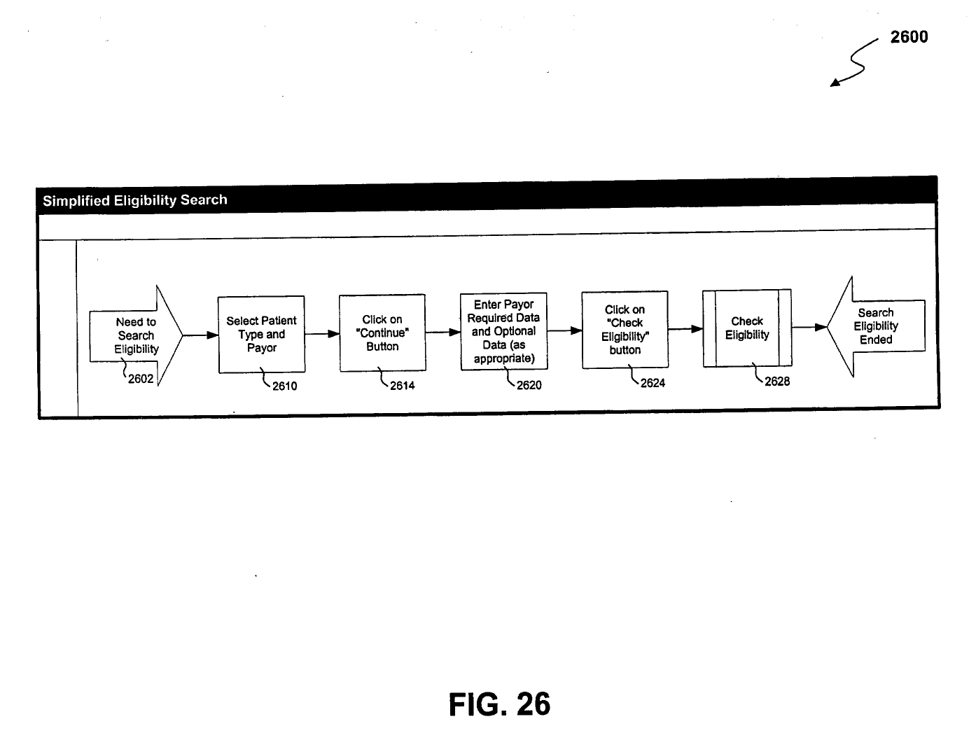

FIG. 26 is a flow chart 2600 which provides a simplified representation of user activity associated with an eligibility search transaction of the present invention. As shown, in a step 2602 user determines that it is necessary or desirable to check the eligibility of a given patient. This could be undertaken in order to determine, for example, a patient's coverage and benefits, benefit detail, medical group, and provider information. The user is initially required to select a Patient Type and Payor; which results in corresponding fields being highlighted in the eligibility search screen (step 2610).

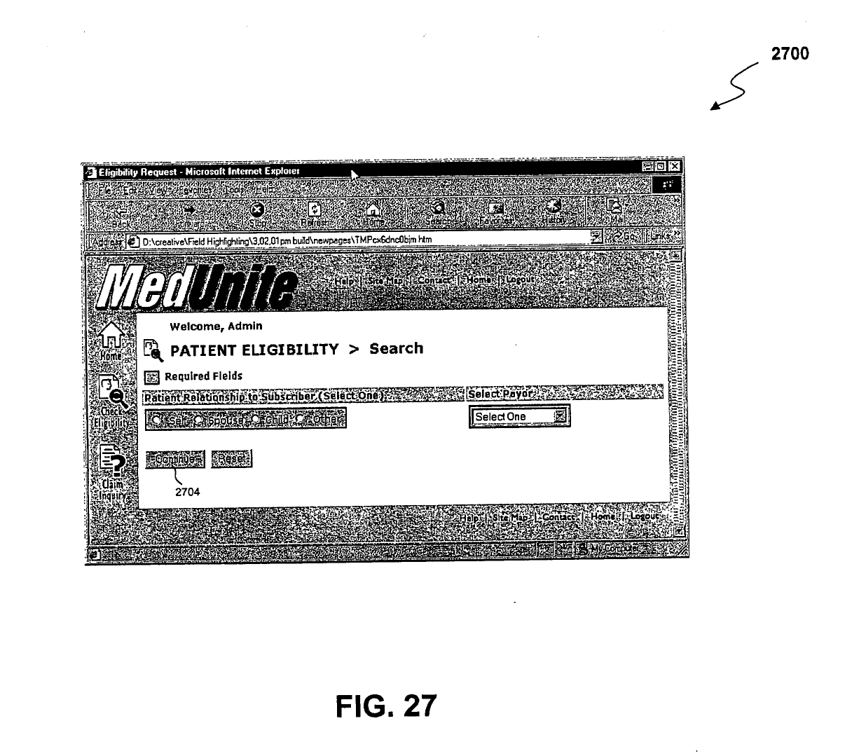

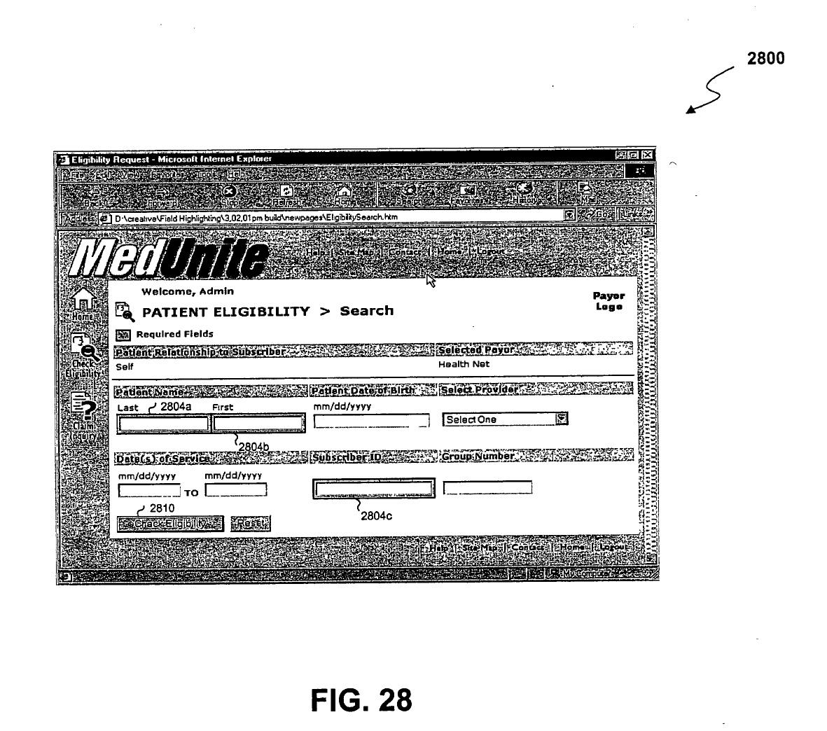

After selecting a Patient Type and Payor; the user then points and clicks on a “continue button” 2704 (FIG. 27) or the like to advance to a second eligibility search screen 2800 depicted in FIG. 28 (step 2614). This second eligibility search screen 2800 is generated by the transaction processing platform 12 for display by the requesting provider computer 14 on the basis of the basis of the parameter selections made by the requesting user. Specifically, the required fields 2804 to be populated by the user within the second eligibility search screen 2800 are based upon the selected Patient Type and Payor and will typically be highlighted. The user then populates the required fields 2804 displayed via the applicable provider computer 14, and may also enter additional data to refine the search (step 2620). Next, the user submits the search data via selection of a “Check eligibility” button 2810 located on the applicable eligibility search screen 2800 (step 2624). In response, the transaction platform 12 effects an eligibility search function pursuant to which information is retrieved from the applicable payor 16 using the mechanics described above with reference to FIG. 7 (step 2628). An eligibility search results screen may then be generated by the transaction platform 12 on the basis of the retrieved eligibility information and transmitted to the requesting provider computer.

The above-referenced provisional application Serial No. 60/340,079 includes a Professional Implementation Guide consistent with the requirements of ANSI ASC X12-Eligibility, Coverage, or Benefit Inquiry (270) and ANSI ASC X12-Eligibility, Coverage, or Benefit Information (271). This Implementation Guide was developed based upon an exemplary set of processing requirements and the 270/271 ANSI ASC X12 transaction format requirements. This Professional Implementation Guide defines where data is placed and when it is included for the 270/271 ANSI ASC X12 transactions to convey health care eligibility and benefit information within the health care transaction processing system 10 of the present invention. This provisional application further includes exemplary DTDs consistent with the 270/271 ANSI ASC X12 transaction format requirements capable of being utilized by the transaction processing platform 12.

### Transaction Processing Platform Utilizing Translation Mechanism

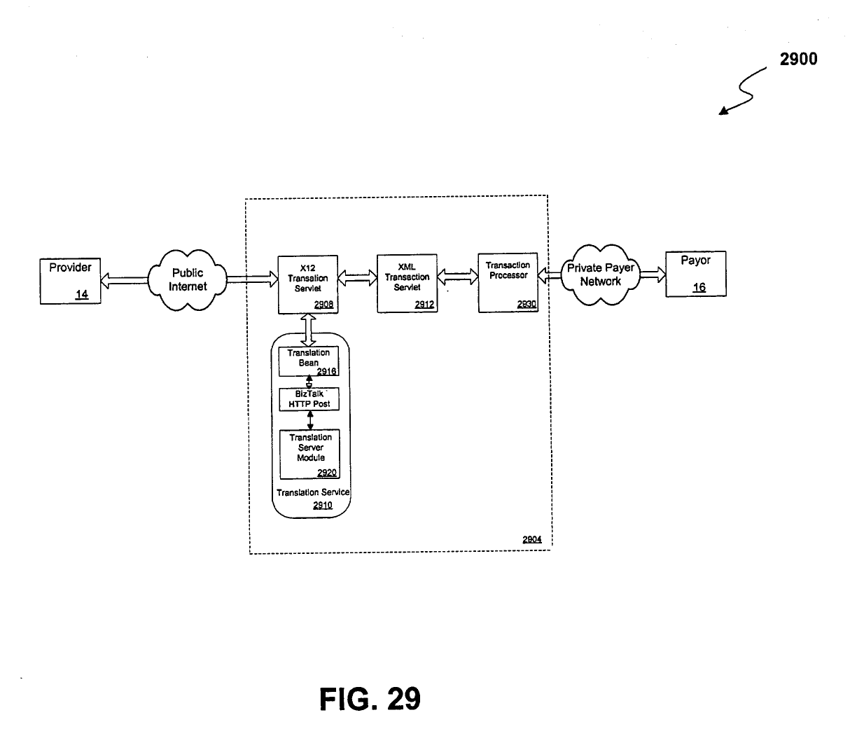

FIG. 29 provides an alternate block diagrammatic representation of an embodiment of a health care transaction processing system 2900 of the present invention. The processing system 2900 of FIG. 29 is substantially similar to the embodiments of the present invention described above, but additional description is provided of a translation service 2910 operative to facilitate the processing of conventionally-formatted ANSI X12N transaction data.

As may be appreciated with reference to FIG. 29, the system 2900 includes a transaction processing platform 2904. During operation of the processing system 2900, transactional requests/responses and associated data are sent and received by an X12 transaction servlet 2908 of the transaction processing platform 2904. The X12 transaction servlet 2908 forwards X12-based data incorporated within HTTP requests received from a given provider 14 to the translation service 2910. As is described below, the translation service 2910 generates a corresponding XML-based request that is forwarded by the X12 translation servlet 2908 to an XML transaction servlet 2912.

As shown, the translation service 2910 includes a translation bean 2916 in communication with a translation server 2920. In operation, the translation server 2920 is operative to convert the received ANSI X12N request and associated transaction data into an XML-based format. In the exemplary embodiment the translation server module 2920 may be implemented using, for example, a BizTalk Server available from Microsoft Corporation (http://www.microsoftl.com/biztalk/).

As mentioned above, the XML-based request produced by the translation service 2910 is forwarded to the XML transaction servlet 2912 via the X12 translation servlet 2908. The XML-based request is then provided to a transaction processor 2930 configured to effect the transaction processing operations described above with reference to FIG. 7. The response generated by the applicable payor 16 is then provided to the X12 transaction servlet 2908 via the XML transaction servlet 2912, which utilizes the translation service 2910 to convert the response to an X12 format intelligible to the requesting provider 14.

In the exemplary embodiment the transaction processing platform 2904 processes requests received from a given provider 14 in a synchronous fashion. That is, the connection with the provider 14 is held open during the period the transaction is being processed (i.e., until a response to the request has been generated by the applicable payor 16 and communicated back to the requesting provider 14). However, in alternate implementations the transaction platform may be implemented so to operate asynchronously, thereby allowing connection resources to be available for other uses during the processing of a given transaction. Such asynchronous transaction processing also frees the requesting provider 14 to perform other activities while the transaction is being processed (e.g., sending of additional transactions). In such an approach a “pseudo-synchronous” mechanism could be utilized in order to provide an essentially synchronous interface to the core components of the transaction processing platform to the extent this would simplify implementation of provider computers 14.

The foregoing description, for purposes of explanation, used specific nomenclature to provide a thorough understanding of the invention. However, it will be apparent to one skilled in the art that the specific details are not required in order to practice the invention. In other instances, well-known circuits and devices are shown in block diagram form in order to avoid unnecessary distraction from the underlying invention. Thus, the foregoing descriptions of specific embodiments of the present invention are presented for purposes of illustration and description. They are not intended to be exhaustive or to limit the invention to the precise forms disclosed, obviously many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated. Many variations, modifications and alternative constructions fall within the scope and spirit of the disclosed invention as expressed in the claims.

What is claimed is:

1. A health care transaction processing system for facilitating information exchange between a health care provider and a plurality of payors, said system comprising:
a health care provider computer configured to generate transaction data of a first predefined format;
a transaction processing platform operatively connected to said health care provider computer, said transaction processing platform (i) converting said transaction data from said first predefined format into a first document formatted consistently with one of a plurality of common data type definitions (DTDs) corresponding to a set of standardized health care transactions, and (ii) translating said first document into a first transaction request document formatted consistently with a second predefined format; and
a first payor computer operatively connected to said transaction processing platform, said first payor computer being associated with a first of said payors and configured to provide a first transaction response document to said transaction processing platform on the basis of said first transaction request document.

2. The health-care care transaction processing system of claim 1 wherein said transaction processing platform supplements said one of said plurality of common DTDs with an optional DTD specific to said first of said payors, said one of said plurality of common DTDs and said optional DTD being used to define said first transaction request document.

3. The health-care care transaction processing system of claim 1 wherein said transaction processing platform converts additional transaction data received from said health care provider computer into a second document formatted consistently with a second of said plurality of common DTDs and translates said second document into a second transaction request document formatted consistently with a third predefined format applicable to a second of said payors.

4. The health-care care transaction processing system of claim 3 wherein said transaction processing platform supplements said second of said plurality of common DTDs with a second optional DTD specific to said second of said payors, said second of said plurality of common DTDs and said second optional DTD being used to define said second transaction request document.

5. The health-care care transaction processing system of claim 3 further including a second payor computer operatively connected to said transaction processing platform, said second payor computer being associated with said second of said payors and configured to provide a second transaction response document to said transaction processing platform on the basis of said second transaction request document.

6. A method for facilitating information exchange between a health care provider and a plurality of payors, said method comprising:
generating, at a facility of said health care provider, transaction data of a first predefined format;
converting said transaction data from said first predefined format into a first document formatted consistently with one of a plurality of common data type definitions (DTDs) corresponding to a set of standardized health care transactions;
translating said first document into a first transaction request document formatted consistently with a second predefined format; and
generating, at a facility of a first of said payors, a first transaction response document on the basis of said first transaction request document.

7. The method of claim 6 further including supplementing said one of said plurality of common DTDs with an optional DTD specific to said first of said payors, said one of said plurality of common DTDs and said optional DTD being used to define said first transaction request document.

8. The method of claim 6 further including converting additional transaction data received from said facility of said health care provider into a second document formatted consistently with a second of said plurality of common DTDs, and translating said second document into a second transaction request document formatted consistently with a third predefined format applicable to a second of said payors.

9. The method of claim 8 wherein said transaction processing platform supplements said second of said plurality of common DTDs with a second optional DTD specific to said second of said payors, said second of said plurality of common DTDs and said second optional DTD being used to define said second transaction request document.

10. The method of claim 8 further including generating a second transaction response document on the basis of said second transaction request document.

11. A health care transaction processing platform comprising:
a web server in communication with a health care provider computer; and
an application server operatively connected to said web server, said application server including:
a central processing unit, and
a memory containing:
an XML processing module operative to convert transaction data received from said health care provider computer in a first predefined format into a first document formatted in accordance with one of a plurality of standardized health care transactions;
a personalization engine configured to translating said first document into a first transaction request document formatted consistently with a second predefined format; and
a core application program including an eligibility module.

12. The health care transaction processing platform of claim 11 wherein said core application program further includes a claim module.

13. The health care transaction processing platform of claim 11 further including a plurality of standardized health transaction interfaces.

14. The health care transaction processing platform of claim 13 further including a first implementation of a first of said plurality of standardized health transaction interfaces and a second implementation of said first of said plurality of standardized health transaction interfaces, said first implementation being associated with a first payor computer facility and said second implementation being associated with a second payor computer facility.

15. The health care transaction processing platform of claim 14 wherein information retrieved from said first payor computer facility via said first implementation of said first of said plurality of standardized health transaction interfaces is converted into an XML-based document.

16. The health care transaction processing platform of claim 14 wherein said XML-based document is converted by said personalization engine into said first predefined format.
